(19) United States
(12) Patent Application Publication
(10) Pub. No.: US 2014/0359195 A1
(43) Pub. Date: Dec. 4, 2014

(54) CROSSBAR SWITCH, INFORMATION PROCESSING APPARATUS, AND INFORMATION PROCESSING APPARATUS CONTROL METHOD

(71) Applicant: FUJITSU LIMITED, Kawasaki-shi (JP)

(72) Inventor: Masaru Nishiyashiki, Kawasaki (JP)

(21) Appl. No.: 14/459,456

(22) Filed: Aug. 14, 2014

Related U.S. Application Data
(63) Continuation of application No. PCT/JP2012/057045, filed on Mar. 19, 2012.

(51) Int. Cl. G06F 13/40

(52) U.S. Cl. CPC G06F 13/409
USPC 710/317

(57) ABSTRACT

A bus connecting ports of a crossbar switch in a ring form is provided, and the configuration information of registers in ports is transferred between ports via the bus and updated, and thus a wiring length of the bus connecting the registers is reduced.

### CROSS-REFERENCE TO RELATED APPLICATION

This application is a continuation application of International Application PCT/JP2012/057045 filed on Mar. 19, 2012 and designated the U.S., the entire contents of which are incorporated herein by reference.

### FIELD

The present invention relates to a crossbar switch, an information processing apparatus, and an information processing apparatus control method.

### BACKGROUND

FIG. 17 is a block diagram illustrating a configuration of a computer system (information processing apparatus) using a crossbar switch including a plurality of ports. The computer system illustrated in FIG. 17 includes a central processing unit (CPU) 10, a main memory 20, an input/output controller (IOC) 30, crossbar switches 40X and 40Y, and I/O devices 50A to 50E.

The CPU 10, the main memory 20, and the IOC 30 are connected with one another via a system bus 60. The I/O devices 50A to 50E are hierarchically connected with the IOC 30 through an I/O bus 70 and the two crossbar switches 40X and 40Y. Each of the crossbar switches 40X and 40Y includes four ports pt0 to pt3. The port pt0 of the crossbar switch 40X is connected with the IOC 30 via the I/O bus 70. The ports pt1 to pt3 of the crossbar switch 40X are connected with the I/O devices 50A and 50B and the port pt0 of the crossbar switch 40Y via the I/O bus 70. The ports pt1 to pt3 of the crossbar switch 40Y are connected with the I/O devices 50C to 50E via the I/O bus 70.

In the computer system having the above configuration, the CPU 10 accesses the I/O devices 50A to 50E through the system bus 60, the IOC 30, the I/O bus 70, and the crossbar switches 40X and 40Y. Further, the I/O devices 50A to 50E access the CPU 10 and the main memory 20 from the port pt0 of the crossbar switch 40X serving as the top of the hierarchy via the IOC 30 and the system bus 60.

In the computer system illustrated in FIG. 17, resources such as registers of the main memory 20 or the I/O devices 50A to 50E are allocated to memory address space as illustrated in FIG. 18, for example. Memory address space (configuration information) is hierarchically set to configuration registers (CFR) of the crossbar switches 40X and 40Y to include space of the I/O devices 50A to 50E under control thereof as illustrated in FIG. 18. FIG. 18 is an explanatory diagram for describing the memory address space of the computer system illustrated in FIG. 17. Referring to FIG. 18, the crossbar switch 40X is denoted by “XB(X)”, and the crossbar switch 40Y is denoted by “XB(Y)”.

FIG. 19 is a diagram illustrating an exemplary configuration of a crossbar switch. FIG. 19 illustrates a detailed configuration of the crossbar switch 40Y, but the crossbar switch 40X has the same configuration as the crossbar switch 40Y. In FIG. 19, an illustration of the CPU 10 and the main memory 20 is not provided.

In the crossbar switches 40X and 40Y, the port pt0 hierarchically closest to the CPU 10 is provided with a register unit (REG) 41 including a CFR as illustrated in FIG. 19. Hereinafter, ports closest to the CPU 10 in the crossbar switches 40X and 40Y are referred to as “upstream ports”. In the example illustrated in FIG. 19, the port pt0 is the upstream port.

Each of the crossbar switches 40X and 40Y includes a packet relay bus 42, a packet transfer destination determination bus 43, and a CFR request/response bus 44.

The packet relay bus 42 connects the ports pt0 to pt3 with one another, and relays packets among the ports pt0 to pt3.

The packet transfer destination determination bus 43 connects the register unit 41 of the port pt0 with the ports pt0 to pt3. Address information in a packet received by each of the ports pt0 to pt3 is compared with the address space set to the CFR of the register unit 41 through the packet transfer destination determination bus 43, and so a transfer destination port of the packet received by each of the ports pt0 to pt3 is decided.

When a packet including a request on the CFR is received from the CPU 10 through the upstream port pt0, the CFR request/response bus 44 notifies of the request on the CFR of the register unit 41, transmits response information from CFR, and updates or reads the configuration information in the CFR. The CFR request/response bus 44 includes a CFR request bus 44a and a CFR response bus 44b. The CFR request bus 44a notifies of an update request or a read request on the CFR of the register unit 41. The CFR response bus 44b transmits the response information from CFR to the update request or the read request.

Next, an operation of the upstream port pt0 in the crossbar switch 40X or 40Y illustrated in FIG. 19 will be described with reference to a flowchart (steps S10 to S21) illustrated in FIG. 20.

When the upstream port (packet receiving port) pt0 receives a packet (step S10), a type of the received packet is determined (step S11). In other words, it is checked whether the data relates to a memory request to request writing/reading on data of the I/O devices 50A to 50E or the main memory 20 or a CFR request to request updating/reading on the CFR of the register unit 41. Hereinafter, a packet related to the memory request is referred to as a “memory request packet”, and a packet related to the CFR request is referred to as a “CFR request packet.”

When the packet is determined to be the memory request packet (a “memory request” route in step S11), a notification of a memory request address of the packet is given to the register unit 41 via the packet transfer destination determination bus 43 (step S12).

The register unit 41 compares the notified memory request address with the address space set to the CFR, and searches for and determines the transfer destination port (step S13). In other words, when there is a port including the notified memory request address in the address space that is under control thereof, the register unit 41 determines the port as the transfer destination port. However, when there is no port including the notified memory request address in the address space that is under control thereof, the register unit 41 determines a port that is hierarchically at a higher level as the transfer destination port.

A notification of information (the transfer destination port number) related to the determined transfer destination port is given from the register unit 41 to the packet receiving port via the packet transfer destination determination bus 43 (step S14). Then, the memory request packet is transfer from the packet receiving port to the transfer destination port via the packet relay bus 42 (step S15). The memory request packet transferred to the transfer destination port is output from the transfer destination port to the I/O device or the crossbar switch that is under control of the transfer destination port (step S16).

When the packet is determined to be the CFR request packet (a “CFR request” route in step S11), a notification of the CFR request of the packet is given to the register unit 41 via the CFR request bus 44a (step S17). The register unit 41 determines whether the notified CFR request is an update (write) request or a read request (step S18).

When the CFR request is determined to be the update request (a YES route in step S18), the CFR in the register unit 41 is updated according to content of the packet, and an update completion notification is given to the packet receiving port via the CFR response bus 44b (step S19). Then, a reply packet for notifying of the CFR update completion is output from the packet receiving port to the CPU 10 (step S20). However, when the CFR request is determined to be the read request (a NO route in step S18), desired information is read from the CFR of the register unit 41, and a notification of the read information is given to the packet receiving port via the CFR response bus 44b (step S21). Then, a reply packet with the notified information is output from the packet receiving port to the CPU 10 (step S20).

FIG. 20 has been described in connection with the operation of the upstream port pt0 illustrated in FIG. 19, but even when packets are received by the ports pt1 to pt3 other than the upstream port pt0 in FIG. 19, an operation similar to that of FIG. 20 is performed. Here, when the memory request packet is received, a notification of the memory request address of the packet is given from the ports pt1 to pt3 to the register unit 41 of the upstream port pt0 via the packet transfer destination determination bus 43. Then, the register unit 41 of the port pt0 compares the notified memory request address with the address space set to the CFR, searches for and determines the transfer destination port, and notifies the packet receiving ports (pt1 to pt3) via the packet transfer destination determination bus 43.

Here, a search period of time for the transfer destination port of the reception packet affects a memory access latency and thus is preferably kept to the minimum. Here, the search period of time for the transfer destination port corresponds to a period of time required for the process of steps S12 to S14 of FIG. 20.

However, only one set of CFRs are physically arranged on a crossbar chip configuring the crossbar switch illustrated in FIG. 19. Thus, when the number of ports mounted on one crossbar chip is increased and thus the area size of the crossbar chip is increased, a physical distance between the upstream port including the CFR and the other ports, that is, the length of the packet transfer destination determination bus 43 is increased. Accordingly, there is a problem in that the search period of time for the transfer destination port of the reception packet is increased.

In this regard, in order to reduce the search period of time for the transfer destination port of the reception packet, for example, register units (REG (copy)) 41a to 41c including a copy of the CFR related to allocation memory address space of all ports are considered to be arranged even in the ports pt1 to pt3 other than the port pt0 as illustrated in FIG. 21. FIG. 21 is a diagram illustrating another exemplary configuration of a crossbar switch. FIG. 21 illustrates a detailed configuration of the crossbar switch 40Y, but the crossbar switch 40X has the same configuration as the crossbar switch 40Y. In FIG. 21, an illustration of the CPU 10 and the main memory 20 is not provided.

In the crossbar switches 40X and 40Y illustrated in FIG. 21, each of the register units 41a to 41c includes a copy (copy CFR) of the CFR included in the register unit 41 of the upstream port pt0. Further, the register units 41a to 41c are connected with the ports pt1 to pt3 via the packet transfer destination determination bus 43a to 43c. As a result, the transfer destination ports of the packets received by the ports pt1 to pt3 are searched and determined by the register units 41a to 41c, respectively, and thus the search period of time for the transfer destination port of the reception packet can be reduced.

Meanwhile, the crossbar switches 40X and 40Y illustrated in FIG. 21, the CFR update request is issued by the CPU 10, and the CFR corresponding to identification information such as a device number or a register number included in the CFR update request is updated according to the identification information. At this time, a CFR update bus 45 connecting the upstream port pt0 with the copy CFRs of the register units 41a to 41c is prepared so that the copy CFRs of the ports pt1 to pt3 are updated in the same manner as the CFR of the upstream port pt0 is performed. Thus, when the CFR of the upstream port pt0 is updated according to the CFR update request, the same CFR update request is transferred to the register units 41a to 41c of the ports pt1 to pt3 via the CFR update bus 45. As a result, the copy CFRs of the register units 41a to 41c are updated in the same manner as the CFR of the port pt0 is updated.

The crossbar switches 40X and 40Y each of which includes the four ports pt0 to pt3 are illustrated in FIG. 21, but a crossbar switch 40X including the eight ports pt0 to pt7 is illustrated in FIG. 22. In the crossbar switch 40X illustrated in FIG. 22, seven CFR update buses 45 installed radially from the port pt0 are prepared between the upstream port pt0 and all the other ports pt1 to pt7. FIG. 22 is a diagram illustrating an exemplary arrangement of the CFR update buses 45 in the crossbar switch 40X.

When N is a total of the number of ports installed on a crossbar chip and the position of the upstream port pt0 is physically fixed, N−1 CFR update buses 45 are used to update all the copy CFRs. For example, in the crossbar switch 40X illustrated in FIG. 22, the seven CFR update buses 45 are used. Further, in order to update all the copy CFRs while allowing the position of the upstream port pt0 to be changed to the position of another port, (N×(N−1)) CFR update buses 45 are used. For example, in the crossbar switch 40X illustrated in FIG. 22, 56 (=8×7) CFR update buses 45 are used.

In the crossbar chip, a physical distance between ports is usually large. Particularly, for example, a physical distance between the ports pt0 and pt4 that are diagonally arranged in the crossbar switch 40X illustrated in FIG. 22 is large. For this reason, a wiring length of the CFR update bus 45 connecting the ports with each other is increased. Thus, when an operation clock frequency is fast, many relay flip flops are additionally inserted into each CFR update bus 45.

### SUMMARY

In one proposal, a crossbar switch is installed between a processor and a plurality of I/O devices, and includes a first port, a second port, a third port, and a bus. The first port is connected with the processor and stores configuration information of the processor and the plurality of I/O devices. The second port is connected to one I/O device among the plurality of I/O devices and stores the configuration information. The third port is connected to another I/O device among the plurality of I/O devices and stores the configuration information. The bus connects the first port, the second port, and the third port in a ring form and propagates the configuration information.

In one proposal, an information processing apparatus includes a processor, a crossbar switch that is connected to the processor, and a plurality of I/O devices that are connected to the crossbar switch, and the crossbar switch includes the first port, the second port, the third port, and the bus.

In one proposal, a control method of an information processing apparatus including a processor, a crossbar switch connected to the processor, and a plurality of I/O devices connected to the crossbar switch, the crossbar switch including a first port that is connected with the processor and stores configuration information of the processor and the plurality of I/O devices, a second port that is connected to one I/O device among the plurality of I/O devices and stores the configuration information, and a third port that is connected to another I/O device among the plurality of I/O devices and stores the configuration information, and the control method includes connecting the first port, the second port, and the third port in a ring form by a bus propagating the configuration information, and when the first port receives an update request for the configuration information from the processor, sequentially transferring the update request for the configuration information to adjacent ports via the bus by the first port, the second port, and the third port.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating a configuration of an information processing apparatus (computer system) using a crossbar switch according to an embodiment.

FIG. 2 is a block diagram illustrating a configuration of a first example of each port in the crossbar switch of the information processing apparatus illustrated in FIG. 1.

FIG. 3 is a flowchart for describing a process when a packet is received in an upstream port having a configuration illustrated in FIG. 2.

FIG. 4 is a flowchart for describing a process when a CFR update request is received in the port having the configuration illustrated in FIG. 2.

FIG. 5 is an explanatory diagram for describing an exemplary CFR update operation in the crossbar switch including the port having a configuration illustrated in FIG. 2.

FIG. 6 is a block diagram illustrating a configuration of a second example of each port in the crossbar switch of the information processing apparatus illustrated in FIG. 1.

FIG. 7 is a flowchart for describing a process when a packet is received in an upstream port having a configuration illustrated in FIG. 6.

FIG. 8 is a flowchart for describing a process when a read/write request for a specific CFR is received in the port having the configuration illustrated in FIG. 6.

FIG. 9 is an explanatory diagram for describing an exemplary specific CFR read operation in the crossbar switch including the port having the configuration illustrated in FIG. 6.

FIG. 10 is a block diagram illustrating a configuration of a third example of each port in the crossbar switch of the information processing apparatus illustrated in FIG. 1.

FIG. 11 is a flowchart for describing a packet delivery acknowledgement process in an upstream port having a configuration illustrated in FIG. 10.

FIG. 12 is a block diagram illustrating a configuration of a fourth example of each port in the crossbar switch of the information processing apparatus illustrated in FIG. 1.

FIG. 13 is a block diagram illustrating a detailed configuration of a timing adjustment control unit in the port having the configuration illustrated in FIG. 12.

FIG. 14 is a timing chart for describing exemplary time division (there is no bus output competition) of a CFR update bus.

FIG. 15 is a timing chart for describing exemplary time division (there is bus output competition) of a CFR update bus.

FIG. 16 is a timing chart for describing a request processing order compensation operation performed by the timing adjustment control unit illustrated in FIGS. 12 and 13.

FIG. 17 is a block diagram illustrating a configuration of a computer system (information processing apparatus) using a crossbar switch including a plurality of ports.

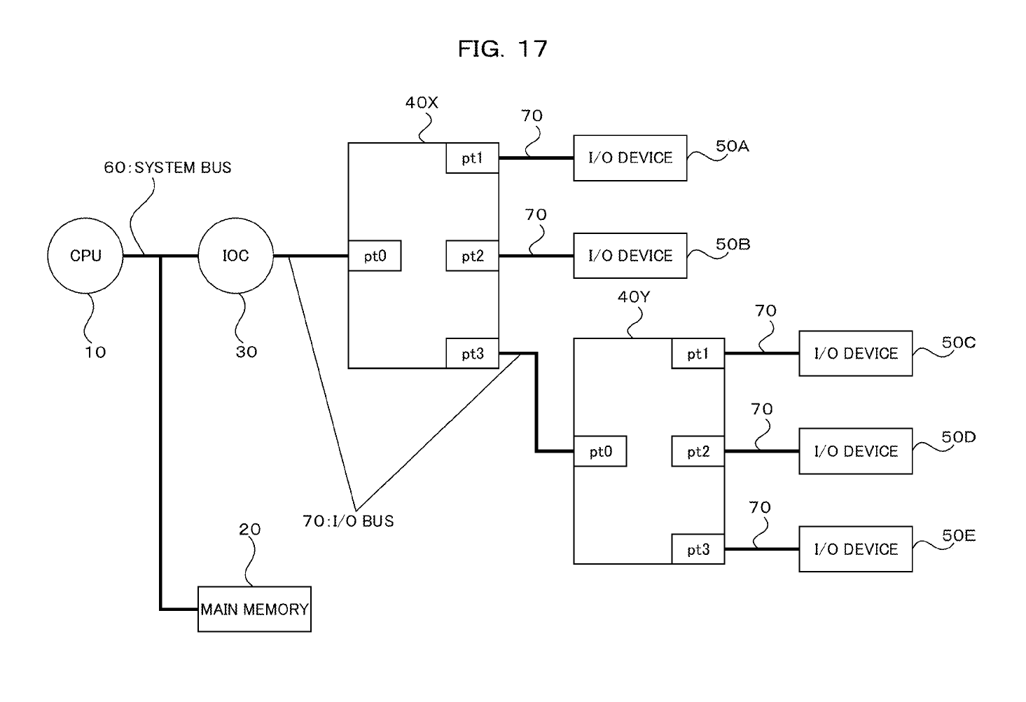

FIG. 18 is an explanatory diagram for describing memory address space of the computer system illustrated in FIG. 17.

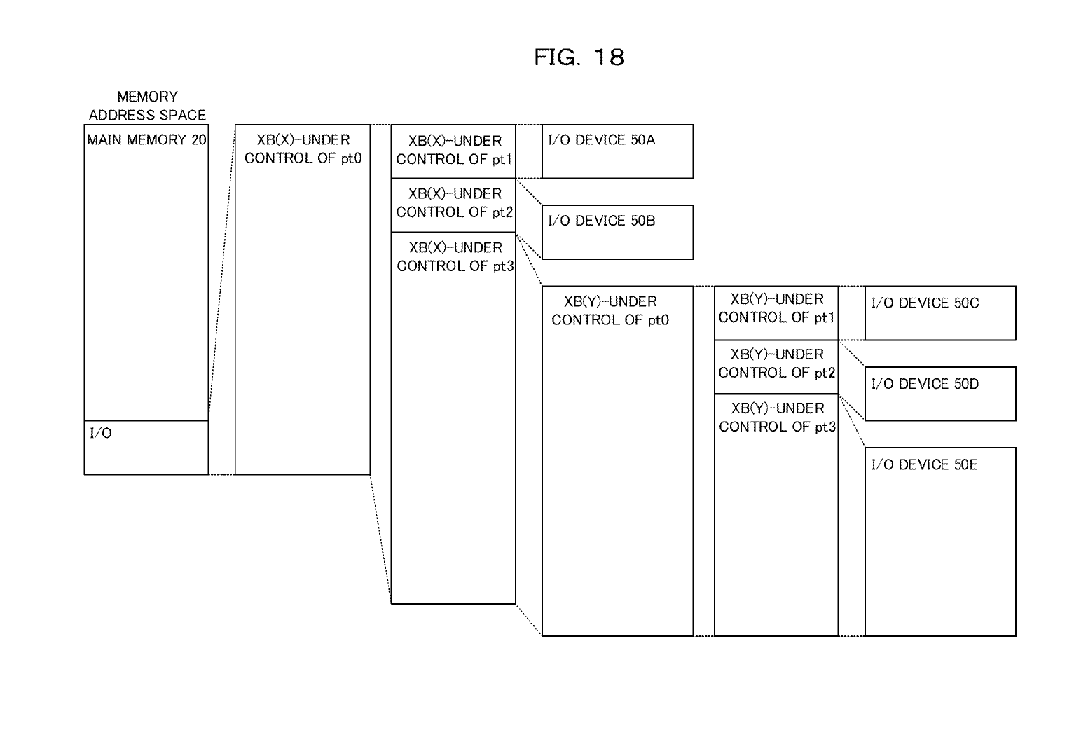

FIG. 19 is a diagram illustrating an exemplary configuration of a crossbar switch.

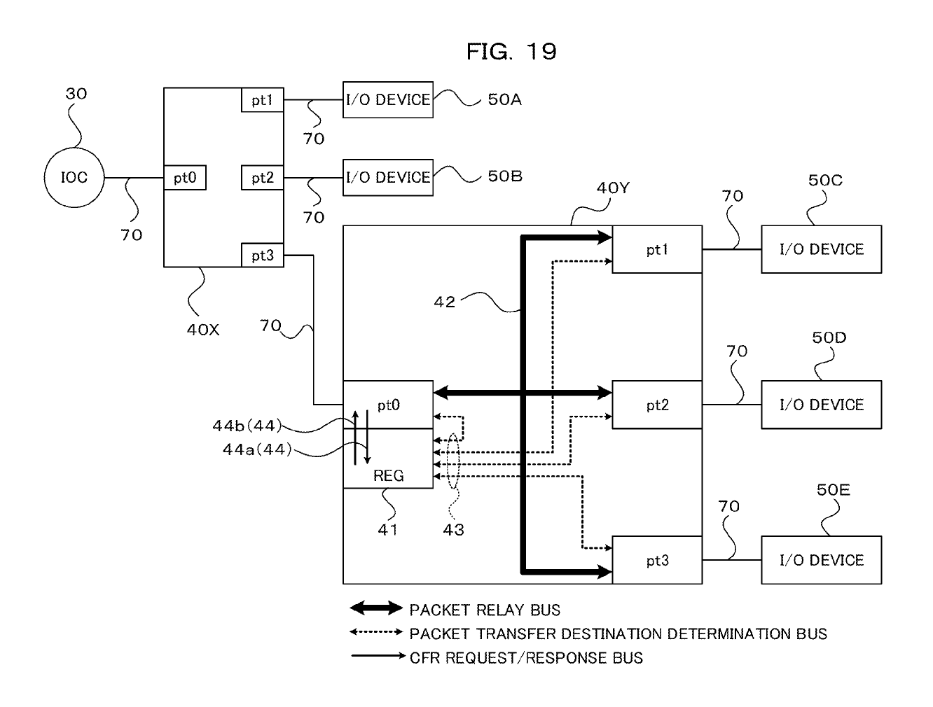

FIG. 20 is a flowchart for describing an operation of an upstream port in the crossbar switch illustrated in FIG. 19.

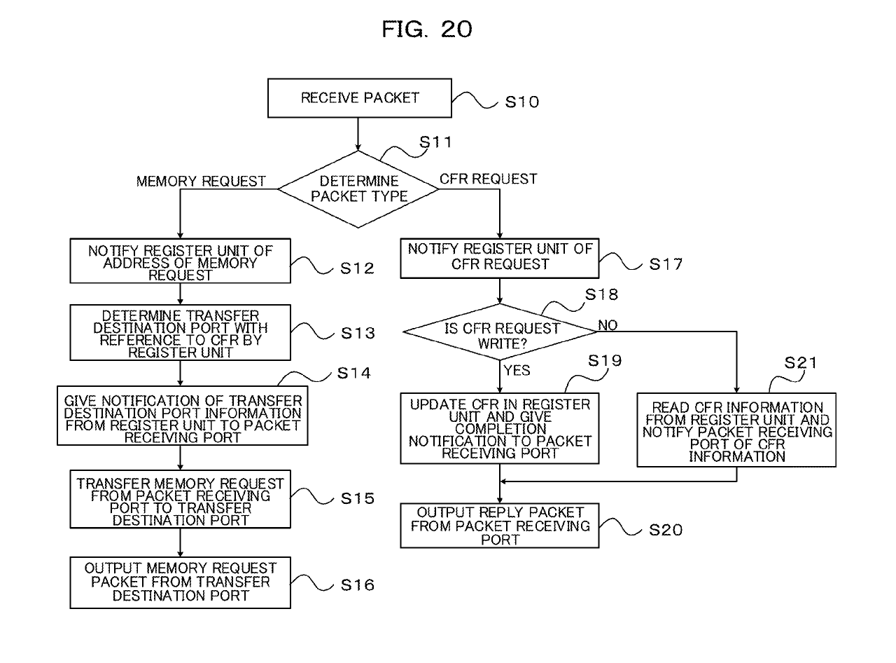

FIG. 21 is a diagram illustrating another exemplary configuration of a crossbar switch.

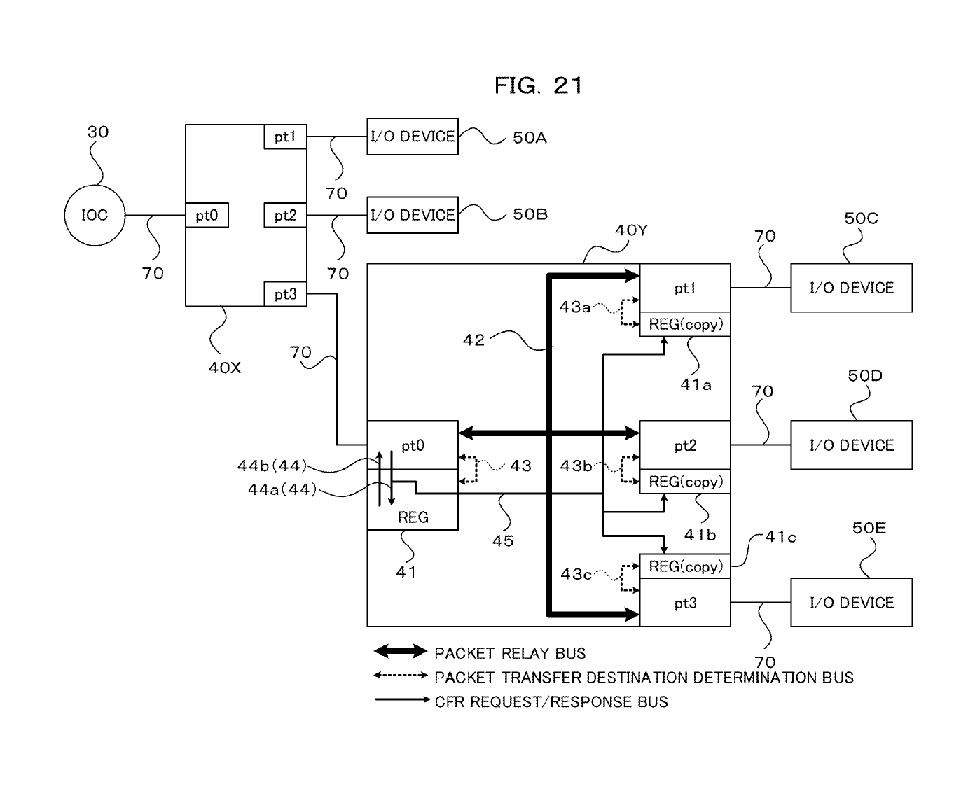

FIG. 22 is a diagram illustrating an exemplary arrangement of a CFR update buses in a crossbar switch.

FIG. 23 is a diagram illustrating an exemplary port arrangement in a crossbar switch to describe the number of relay flip flops (FFs) to be inserted into a CFR update bus.

### DESCRIPTION OF THE PREFERRED EMBODIMENTS

Hereinafter, exemplary embodiments will be described with reference to the appended drawings.

[1] Information Processing Apparatus According to Present Embodiment

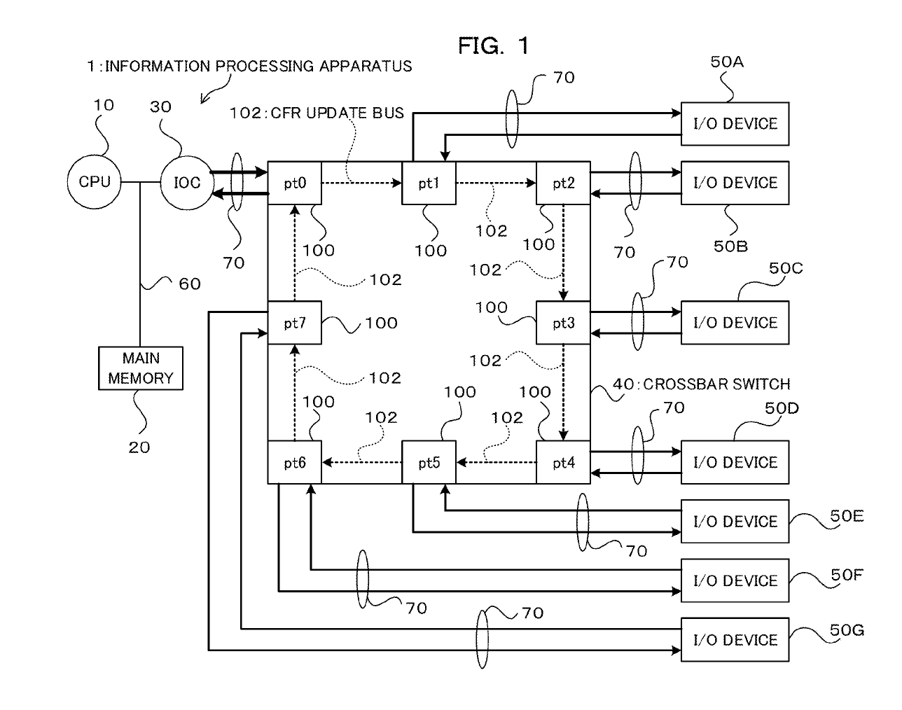

FIG. 1 is a block diagram illustrating a configuration of an information processing apparatus (computer system) 1 using a crossbar switch 40 according to an embodiment. The information processing apparatus 1 illustrated in FIG. 1 includes a CPU (processor) 10, a main memory 20, an IOC (IO control device) 30, a crossbar switch 40, and I/O devices 50A to 50G. As reference numerals denoting the I/O devices, “50A” to “50G” are used to identify respective I/O devices, and “50” is used to indicate an arbitrary I/O device.

The CPU 10, the main memory 20, and the IOC 30 are connected with one another via a system bus 60. The I/O devices 50A to 50G are connected with the IOC 30 via an I/O bus 70 and the crossbar switch 40. The crossbar switch 40 includes eight ports (pt0 to pt7) 100. As reference numerals of ports, “pt0” to “pt7” are used to identify respective ports, and “100” is used to indicate an arbitrary port.

The CPU 10 is connected to the port pt0 (a first port) of the crossbar switch 40 via the I/O bus 70 and the IOC 30. Hereinafter, the port pt0 closes to the CPU 10 in the crossbar switch 40 is also referred to as an “upstream port”.

The I/O devices 50A to 50G are connected to the ports pt1 to pt7 (a second port and a third port) of the crossbar switch 40 via the I/O bus 70. In the present embodiment, the ports pt1 to pt7 are connected with the I/O devices 50 via the I/O bus 70 but may be connected with another crossbar switch 40. In this case, the I/O device 50 or the like are hierarchically connected to the IOC 30 via the I/O bus 70 and two or more crossbar switches 40.

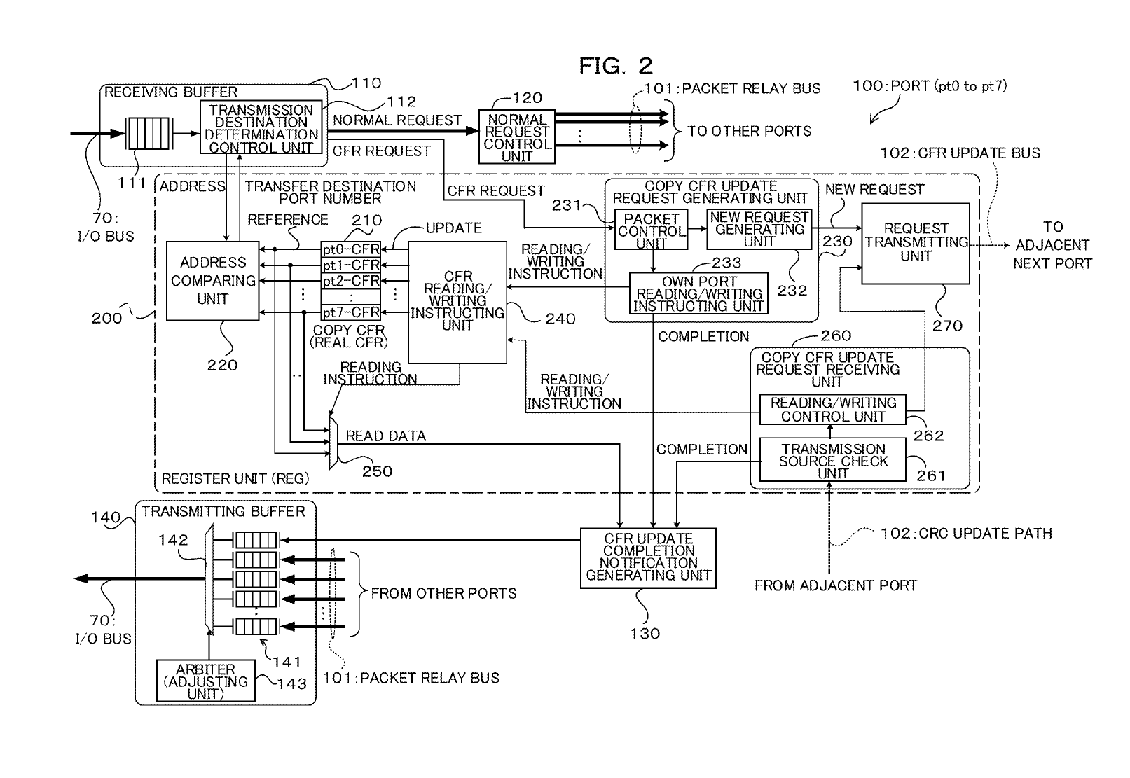

Each port 100 includes a CFR 210 (not illustrated in FIG. 1) which will be described later with reference to FIG. 2. The CFR 210 is a configuration register that stores configuration information (memory address space) of the CPU 10 and the I/O device 50.

The port pt0 to pt7 in the crossbar switch 40 are connected with one another via a packet relay bus 101 (not illustrated in FIG. 1, and see FIG. 2). The packet relay bus 101 relays packets among the ports pt0 to pt7. Upon receiving a memory request packet, each port 100 searches the CFR 210, determines a transfer destination port, and transfer the memory request packet to the determined transfer destination port via the packet relay bus 101.

Further, the ports pt0 to pt7 (the first port, the second port, and the third port) of the crossbar switch 40 are connected in a ring form via a CFR update bus 102 to update the configuration information in the CFR 210 of each port 100 according to a CFR update request received from the CPU 10. In other words, the CFR update bus 102 connects the ports pt0 to pt7 in a loop form (a chain form), and propagates the CFR update request including the configuration information serving as update content received from the CPU 10 in the order of the ports pt0→pt1→pt2→pt3→pt4→pt5→pt6→pt7→pt0 (clockwise in FIG. 1).

Upon receiving a CFR update request packet from the CPU 10, the upstream port pt0 updates the CFR 210 of the port pt0, and transfers the CFR update request to the next port pt1 via the CFR update bus 102. Upon receiving the CFR update request from the port at the previous stage via the CFR update bus 102, each of the ports pt1 to pt7 updates the CFR 210 of each of the ports pt1 to pt7, and transfers the CFR update request to the next port via the CFR update bus 102. Upon receiving the CFR update request transferred by the upstream port pt0 from the port pt7 at the previous stage via the CFR update bus 102, the upstream port pt0 notifies the CPU 10 of completion of the update of the CFR 210.

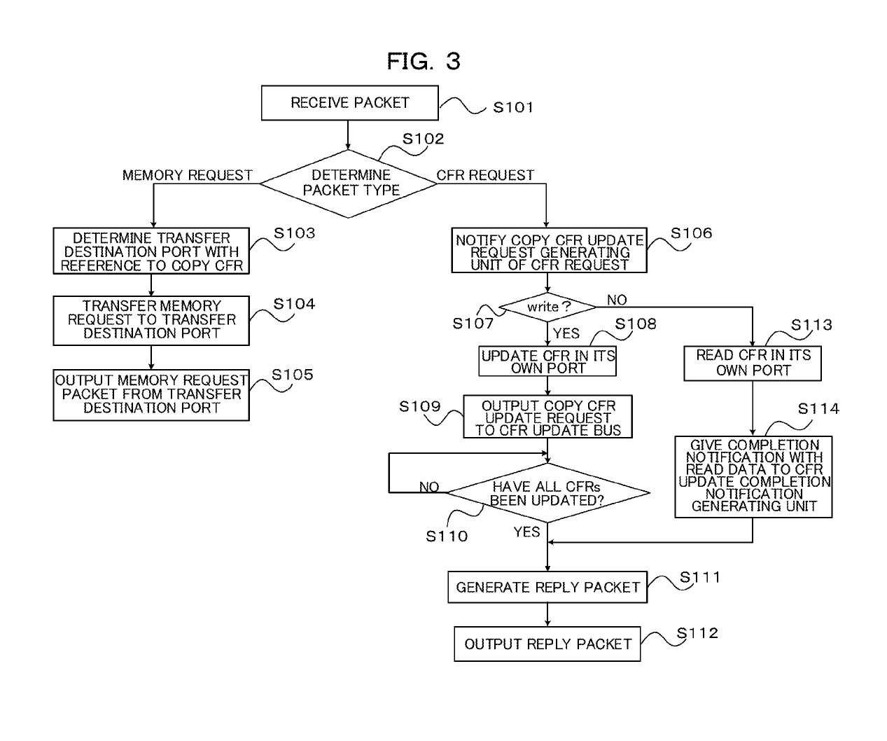

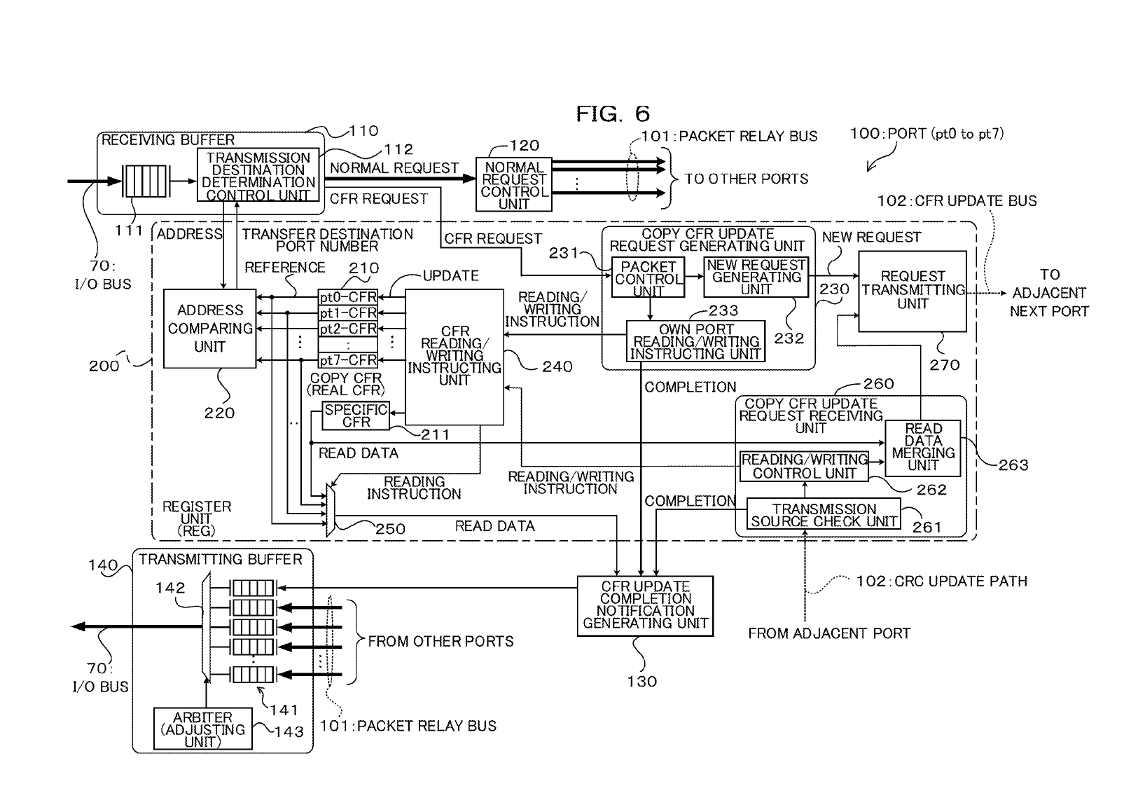

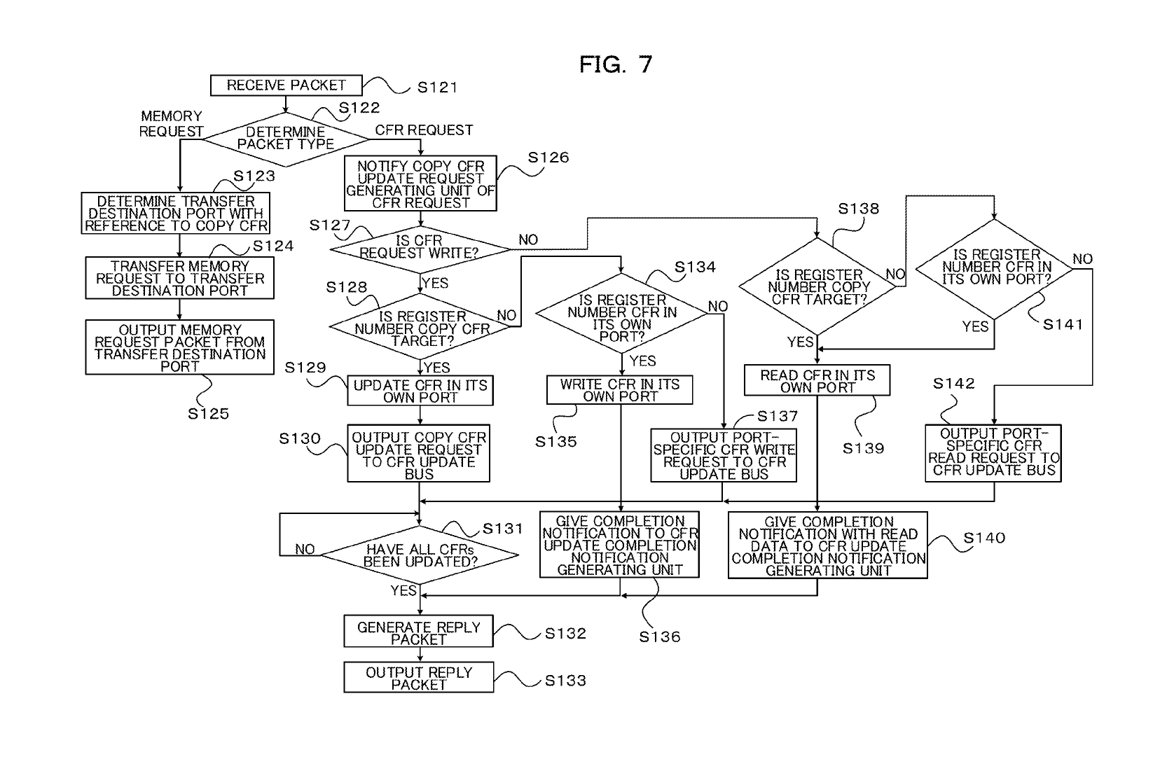

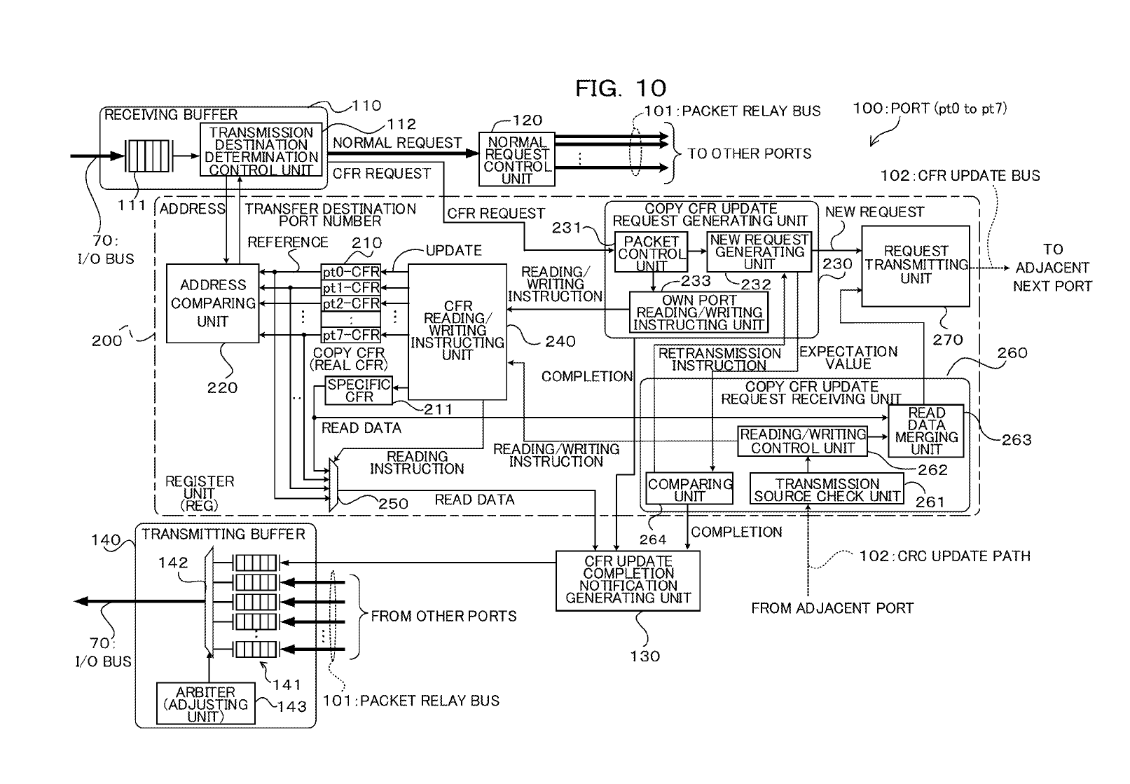

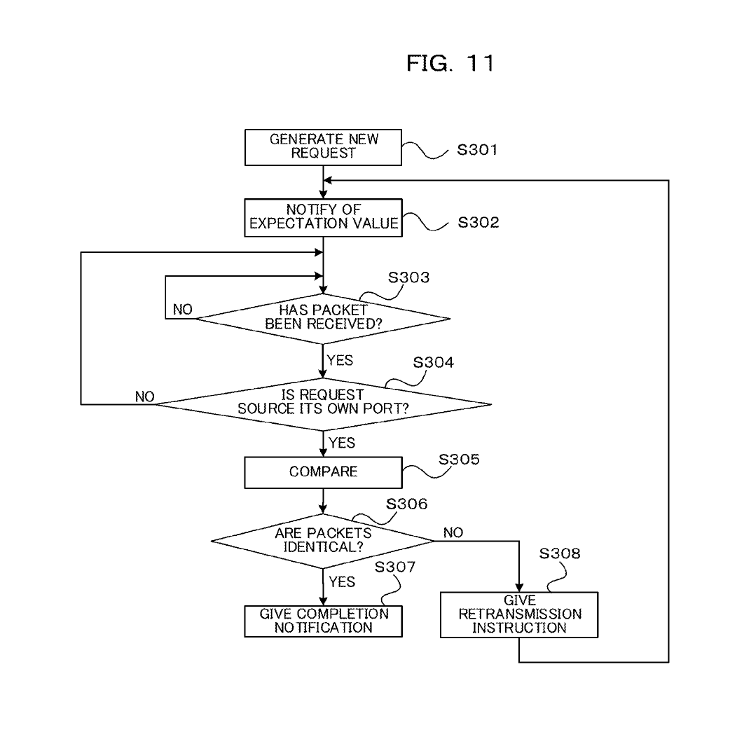

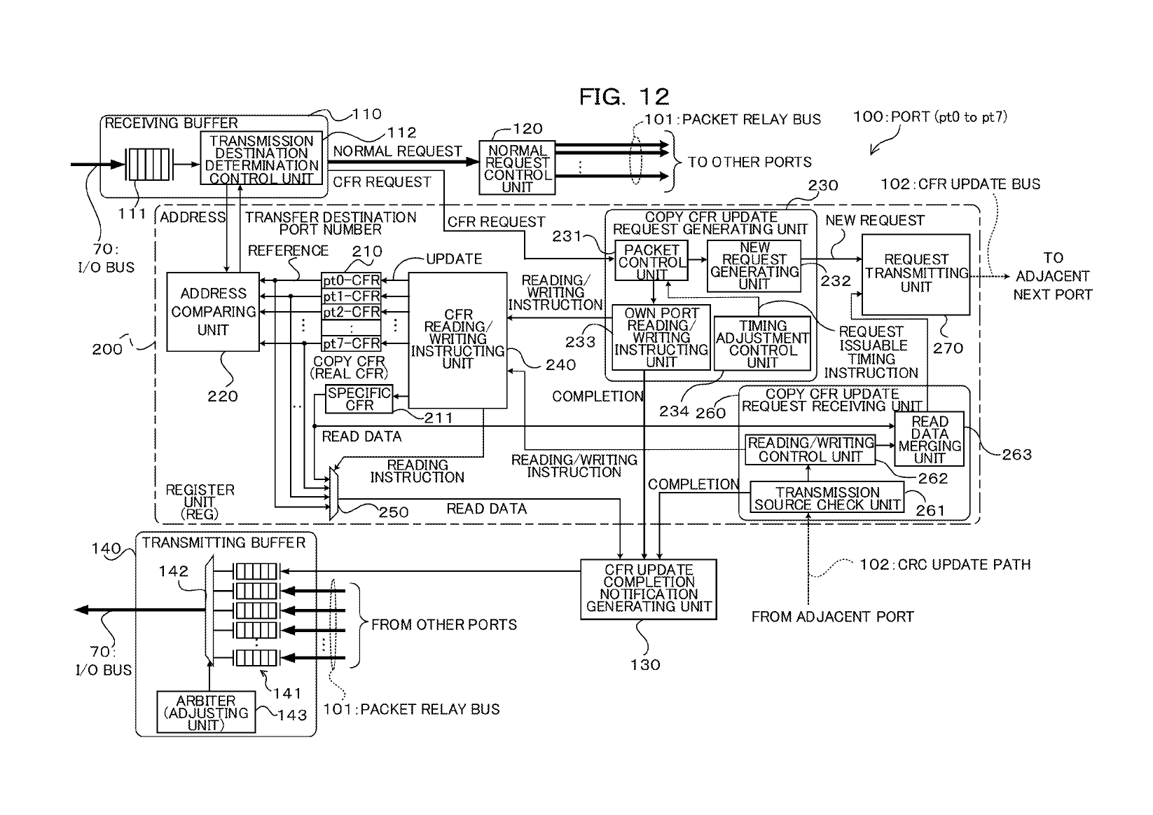

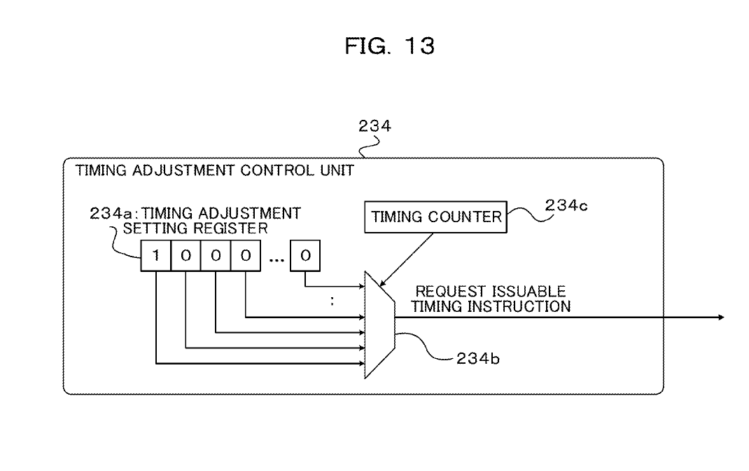

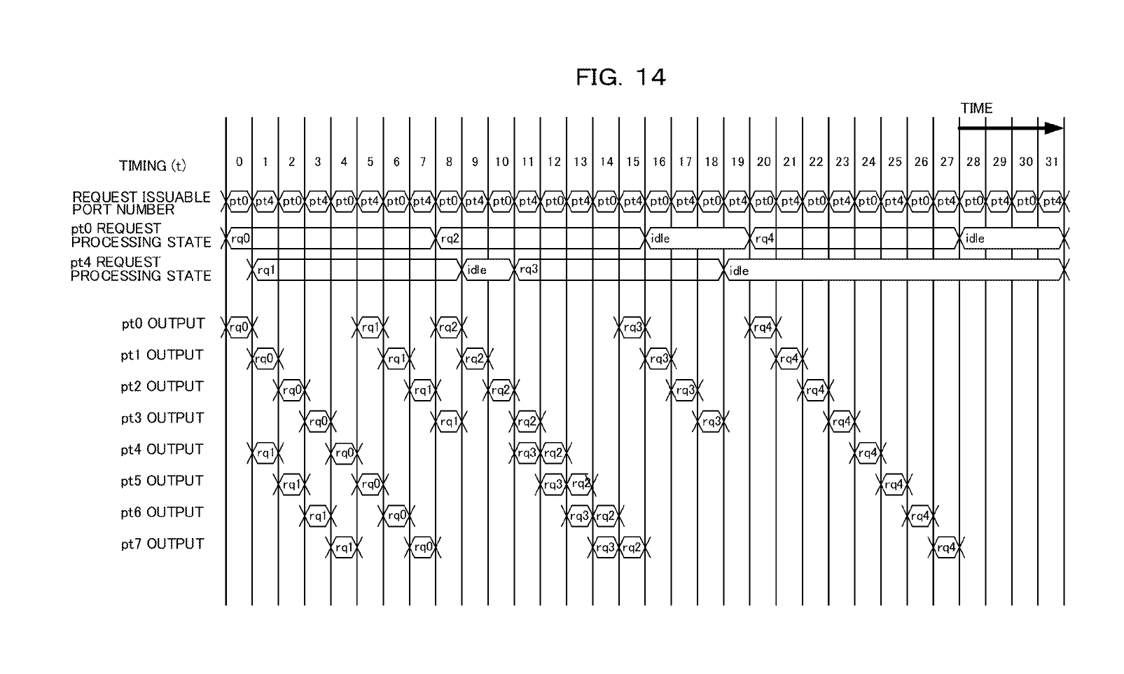

Concrete port configurations (first to fourth examples) for implementing the memory request transfer process and the CFR update request transfer process in the information processing apparatus 1 according to the present embodiment will be described with reference to FIG. 2, FIG. 6, FIG. 10, FIG. 12, and FIG. 13. The memory request transfer process and the CFR update request transfer process will be concretely described with reference to FIG. 3 to FIG. 5, FIG. 7 to FIG. 9, FIG. 11, and FIG. 14 to FIG. 16.

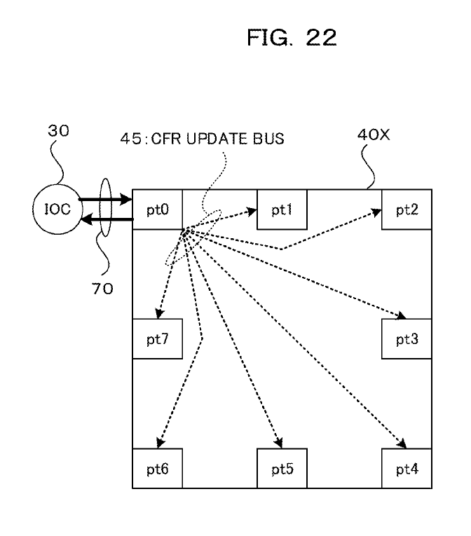

As described above, in the crossbar switch 40 of the present embodiment, the CFR update bus 102 connecting the ports pt0 to pt7 in a ring form is wired instead of the seven CFR update buses 45 radially wired from the port pt0 to the ports pt1 to pt7 as illustrated in FIG. 22. As a result, the CFR update request including the configuration information is sequentially propagated to each port 100 via each CFR update bus 102 (clockwise in FIG. 1), and the configuration information in each port 100 is updated.

Thus, when the ports 100 are connected in a ring form through the CFR update bus 102 as illustrated in FIG. 1, the wiring length of the CFR update bus 102 can be reduced to be smaller than when the CFR update buses are radially wired (see FIG. 22). In other words, since the physical distance between the adjacent ports 100 is small, the wiring length of the CFR update bus 102 can be reduced. Since the wiring length of the CFR update bus 102 can be reduced as described above, even when the physical operation clock frequency of the crossbar switch 40 is fast, the number of flip flops (FF) necessary for a relay of the CFR update bus 102 propagating the CFR update request including the configuration information can be reduced.

Further, the CFR update bus 102 is wired in a ring form in an outer peripheral region of the crossbar chip configuring the crossbar switch 40. Thus, it is unnecessary to wire many buses connecting the ports 100 on the same chip, for example, many CFR update buses in an inner area in which the packet relay bus 101 is wired across a long distance, and thus there is an advantage of increasing a degree of freedom of a wiring layout on the same chip.

In addition, as the ports 100 having the same configuration are connected in a ring form through the CFR update bus 102 as will be described later, it is possible to change all of a plurality of ports 100 to the upstream port pt0 without adding the CFR update bus 102. Here, when N is a total of the number of ports installed on a crossbar chip, in order to update all the CFRs 210 while allowing the position of the upstream port pt0 to be changed to the position of another port, (N×(N−1)) CFR update buses 45 are used in the technique illustrated in FIG. 22. On the other hand, the number of CFR update buses 102 used in the crossbar switch 40 of the present embodiment is N. For example, when N is 8 as in the present embodiment, the number of CFR update buses 45 used in the technique illustrated in FIG. 22 is 56, but the number of CFR update buses 102 used in the present embodiment is 8. As described above, in the crossbar switch 40 of the present embodiment, particularly, when the upstream port pt0 is configured to be changed to another the port 100, the number of CFR update buses 102 and the wiring length thereof can be significantly reduced, and the number of FFs used for a relay of the CFR update bus 102 can be reduced.

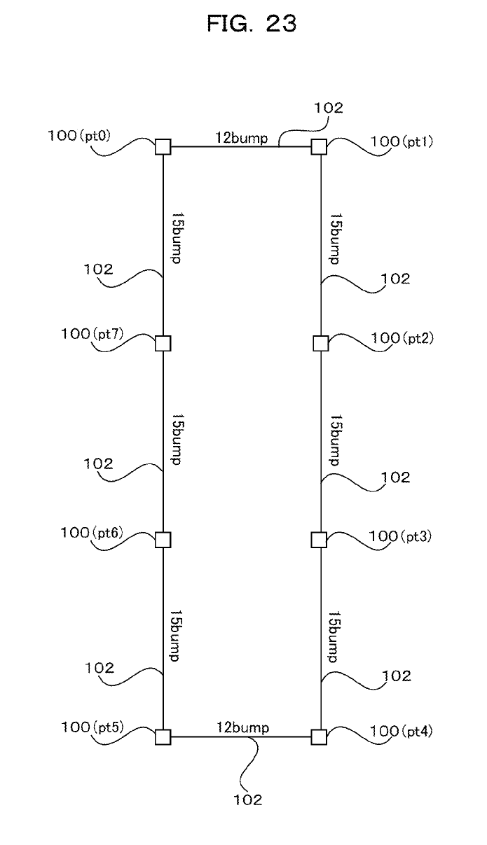

Here, the number of relay FFs used when the CFR update buses are radially wired (see FIG. 22) and the number of relay FFs used when the ports 100 are connected in a ring form through the CFR update bus 102 as illustrated in FIG. 1 will be concretely described with reference to FIG. 23. FIG. 23 is a diagram illustrating an exemplary port arrangement in the crossbar switch 40 (crossbar chip).

Referring to FIG. 23, the number of ports 100 (pt0 to pt7) is 8, the four ports pt0, pt7, pt6, and pt5 and the four ports pt1 to pt4 are arranged in the horizontal direction in FIG. 23 to face each other with an interval of 12 bumps. The four ports pt0, pt7, pt6, and pt5 are arranged in the vertical direction in FIG. 23 with an interval of 15 bumps, and similarly, the four ports pt1 to pt4 are arranged in the vertical direction in FIG. 23 with an interval of 15 bumps as well. 1 bump is an interval (for example, 150 μm) of a bump of a crossbar chip, and a distance of a signal propagating through a bus with one control clock τ is 3000 μm.

At this time, when the CFR update buses are radially wired as illustrated in FIG. 22 for the eight ports 100 illustrated in FIG. 23 while allowing the upstream port pt0 to be changed to another port 100, a total of 108 relay FFs are inserted into the 56 CFR update buses. However, when the ports 100 are connected in a ring form by the CFR update bus 102 as illustrated in FIG. 1 for the eight ports 100 illustrated in FIG. 23, one relay FF is inserted into each of the eight CFR update buses 102, and thus a total of 8 relay FFs are used. As the ports 100 are connected in a ring form by the CFR update bus 102 as in the present embodiment as described above, the number of relay FFs inserted into the CFR update bus can be significantly reduced.

[2] Detailed Configuration of Each Port in Crossbar Switch and Operation of Crossbar Switch

Next, configurations of first to fourth examples of each port in the crossbar switch 40 configuring the information processing apparatus 1 and an operation and effect obtained by a configuration of each example will be concretely described with reference to FIGS. 2 to 16.

[2-1] Port of First Example

[2-1-1] Configuration of Port of First Example

FIG. 2 is a block diagram illustrating a configuration of a first example of each port 100 in the crossbar switch 40 of the information processing apparatus 1 illustrated in FIG. 1. The port 100 of the first example illustrated in FIG. 2 includes a receiving buffer 110, a normal request control unit 120, a CFR update completion notification generating unit 130, a transmitting buffer 140, and a register unit 200.

The receiving buffer 110 is connected to at least one of the CPU 10, the I/O device 50, and another crossbar switch 40 via the I/O bus 70, and receives various kinds of packets from at least one of the CPU 10, the I/O device 50, and another crossbar switch 40. Similarly, the transmitting buffer 140 is connected to at least one of the CPU 10, the I/O device 50, and another crossbar switch 40 via the I/O bus 70, and transmits various kinds of packets to at least one of the CPU 10, the I/O device 50, and another crossbar switch 40.

In the present embodiment, the port pt0 is an upstream port connected to the CPU 10, and the receiving buffer 110 and the transmitting buffer 140 of the port pt0 are connected to the CPU 10 via the I/O bus 70, the IOC 30, and the system bus 60. Further, the receiving buffers 110 and the transmitting buffers 140 of the ports pt1 to pt7 are connected to the I/O devices 50A to 50G via the I/O bus 70.

The receiving buffer 110 includes a holding unit 111 and a transmission destination determination control unit 112.

The holding unit 111 is a memory (queue) of a first-in first-out (FIFO) type that sequentially holds packet received from the I/O bus 70, and outputs the same packets in the input order.

The transmission destination determination control unit 112 determines a type of a packet received from the holding unit 111. When the packet is the memory request packet, the transmission destination determination control unit 112 notifies an address comparing unit 220 which will be described later of the memory request address of the packet, and receives a transfer destination port number corresponding to the address from the address comparing unit 220. Thereafter, the transmission destination determination control unit 112 notifies the normal request control unit 120 of the normal request (the memory request) including the transfer destination port number. Meanwhile, when the packet is the CFR request packet, the determination control unit 112 notifies a packet control unit 231 which will be described later of the CFR request.

The normal request control unit 120 is connected to the packet relay bus 101 directed to another port 100, and transfers the normal request received from the receiving buffer 110 to another port 100 according to the transfer destination port number of the normal request via the packet relay bus 101.

Upon receiving a completion notification from an own port reading/writing instructing unit 233 which will be described later or a transmission source check unit 261 which will be described later, the CFR update completion notification generating unit 130 generates a reply packet to the CPU 10, and outputs the reply packet to the transmitting buffer 140. When the CFR request relates to data reading, the CFR update completion notification generating unit 130 adds read data received from a selector 250 which will be described later or read data (which will be described later) included in the completion notification received from the transmission source check unit 261 which will be described later to the reply packet. Further, basically, the CFR update completion notification generating unit 130 according to the present embodiment is assumed to generate the reply packet according to the completion notification received from the transmission source check unit 261 which will be described later.

The transmitting buffer 140 includes a plurality of holding units 141, a selector 142, and an arbiter 143.

One of the plurality of holding units 141 is a memory (queue) of a FIFO type that sequentially holds notification packets received from the CFR update completion notification generating unit 130, and outputs the same packets in the input order. The other holding units 141 are memories (queues) of a FIFO type that sequentially holds packets from another port 100 via the packet relay bus 101, and outputs the same packets in the input order.

The selector 142 selects a packet from one of the plurality of holding units 141 according to a selection signal received from the arbiter 143 which will be described later, and outputs the selected packet to the I/O bus 70.

The arbiter (adjusting unit) 143 outputs the selection signal for selecting one of the plurality of holding units 141 to the selector 142 according to a packet holding state in the plurality of holding units 141, an adjustment instruction given from a control unit (not illustrated), or the like.

The register unit (REG) 200 includes a copy CFR 210, the address comparing unit 220, a copy CFR update request generating unit 230, a CFR reading/writing instructing unit 240, the selector 250, a copy CFR update request receiving unit 260, and a request transmitting unit 270.

The copy CFRs (first to third registers) 210 store configuration information to be written according to the CFR update request received from the CPU 10. The configuration information specifies memory address space allocated to resources such as the main memory 20 or registers on the I/O devices 50A to 50G in the information processing apparatus 1. The copy CFR (the first register) 210 in the port pt0 serving as the upstream port functions as a real CFR as well. The copy CFRs (the second and third registers) 210 in the other ports pt1 to pt7 store a copy the configuration information in the real CFR.

The address comparing unit 220 compares the memory request address received from the transmission destination determination control unit 112 with the configuration information (address space) stored in the CFR 210, and searches for and determines the transfer destination port number identifying the transfer destination port. When there is a port in which the memory request address notified from the transmission destination determination control unit 112 is included in address space under control thereof, the address comparing unit 220 transmits the transfer destination port number identifying the corresponding port to the transmission destination determination control unit 112.

The copy CFR update request generating unit 230 functions in the upstream port (the port pt0 in FIG. 1), and generates the CFR update request as a new request when the CFR request received from the transmission destination determination control unit 112 is an update request for the copy CFR 210. The copy CFR update request generating unit 230 includes the packet control unit 231, a new request generating unit 232, and the own port reading/writing instructing unit 233.

When the CFR request received from the transmission destination determination control unit 112 is the read request, the packet control unit 231 outputs a read instruction to the own port reading/writing instructing unit 233. When the CFR request received from the transmission destination determination control unit 112 is the write request (the update request), the packet control unit 231 outputs a write instruction (an update instruction) to the new request generating unit 232 and the own port reading/writing instructing unit 233.

The new request generating unit 232 generates and outputs a new request packet (a CFR update request packet) for updating the copy CFR 210 according to the write instruction given from the packet control unit 231. The new request generating unit 232 may output the request packet received from the CPU 10 as a new request packet.

The own port reading/writing instructing unit 233 gives the read or write instruction to read or write the configuration information from or in the CFR 210 in its own port according to the read instruction or the write instruction given from the packet control unit 231. Further, the own port reading/writing instructing unit 233 may be configured to outputs the completion notification for notifying of the update completion to the CFR update completion notification generating unit 130 when the update instruction to update the configuration information in the CFR 210 in its own port is given.

The CFR reading/writing instructing unit 240 reads or writes (updates) the configuration information from or in the copy CFR 210 according to the read/write instruction given from the copy CFR update request generating unit 230 or the copy CFR update request receiving unit 260 which will be described later.

The selector 250 outputs the configuration information read from the copy CFR 210 as the read data the read instruction given from the CFR reading/writing instructing unit 240 by a selective switching.

The copy CFR update request receiving unit 260 receives the CFR update request from the adjacent port 100 via the CFR update bus 102, and relays the update instruction and the CFR update request of the copy CFR 210. The copy CFR update request receiving unit 260 includes the transmission source check unit 261 and a reading/writing control unit 262.

The transmission source check unit 261 determines whether or not the CFR update request packet has been output from its own port with reference to transmission source information of the CFR update request packet received from the adjacent port 100 via the CFR update bus 102. For example, the transmission source information is information that is added to the CFR update request packet when the CFR update request packet is generated by the new request generating unit 232 and identifies an upstream port such as a port number. The transmission source check unit 261 compares the port number of its own port with the port number serving as the transmission source information of the CFR update request packet, and determines that the CFR update request packet has been output from its own port when the port numbers are identical to each other. When the CFR update request packet is determined to have been output from its own port, the transmission source check unit 261 outputs the completion notification for notifying of that all the CFRs 210 have been completely updated to the CFR update completion notification generating unit 130. Meanwhile, when the CFR update request packet is determined to have not been output from its own port, the transmission source check unit 261 outputs a control instruction to the reading/writing control unit 262, and transfers the received CFR update request packet as a relay packet.

The reading/writing control unit 262 gives the write (update) instruction to write (update) the configuration information in the CFR 210 according to instruction content of the CFR update request packet in response to the control instruction given from the transmission source check unit 261. In other words, the reading/writing control unit 262 gives the write (update) instruction to write (update) the configuration information in the CFR 210 when the instruction content of the received CFR update request packet is the write request (the update request). Further, when the instruction content of the received CFR update request packet is the write request (the update request), the reading/writing control unit 262 transfers the received CFR update request packet to the request transmitting unit 270 as the relay packet.

Further, the reading/writing control unit 262 can read the configuration information from the CFR 210 according to the instruction content of the CFR update request packet in response to the control instruction given from the transmission source check unit 261. In other words, the reading/writing control unit 262 gives the read instruction to read the configuration information from the CFR 210 when the instruction content of the received CFR update request packet is the read request.

The request transmitting unit 270 outputs the new request received from the new request generating unit 232 or the relay request received from the reading/writing control unit 262 to the CFR update bus 102, and transfers the new request or the relay request to the adjacent port 100 via the CFR update bus 102. The request transmitting unit 270 in the upstream port (the port pt0 in FIG. 1) outputs the new request received from the new request generating unit 232 to the CFR update bus 102. Meanwhile, the request transmitting unit 270 in the ports (the ports pt1 to pt7 in FIG. 1) other than the upstream port output the relay request received from the reading/writing control unit 262 to the CFR update bus 102.

[2-1-2] Operation of Port of First Example

Next, an operation of the port 100 having the configuration illustrated in FIG. 2 and an operation of the crossbar switch 40 including the port 100 having the configuration illustrated in FIG. 2 will be described with reference to FIGS. 3 to 5.

First, a process when a packet is received in the upstream port 100 (pt0) having the configuration illustrated in FIG. 2 will be described with reference to a flowchart (steps S101 to S112) illustrated in FIG. 3.

Upon receiving a packet through the receiving buffer 110 of the upstream port pt0 (step S101), the transmission destination determination control unit 112 determines a type of a packet (step S102). When the transmission destination determination control unit 112 determines that the packet is the memory request packet (“memory request” route in step S102), a notification of a memory request address of the packet is given to the address comparing unit 220. The address comparing unit 220 compares the notified memory request address with the configuration information (address space) stored in the CFR 210 with reference to the CFR 210, and searches for and determines the transfer destination port number identifying the transfer destination port (step S103).

The transfer destination port number is transmitted from the address comparing unit 220 to the transmission destination determination control unit 112, and the transmission destination determination control unit 112 notifies the normal request control unit 120 of the normal request including the transfer destination port number. The normal request control unit 120 transfers the normal request (the memory request) received from the receiving buffer 110 to another port 100 corresponding to the transfer destination port number of the normal request via the packet relay bus 101 (step S104). The memory request packet transferred to the transfer destination port is output from the transfer destination port to the I/O device 50 or the crossbar switch 40 that is under control of the transfer destination port (step S105).

Meanwhile, when the transmission destination determination control unit 112 determines that the packet is the CFR request packet (“CFR request” route in step S102), a notification of the CFR request is given from the receiving buffer 110 to the packet control unit 231 of the copy CFR update request generating unit 230 (step S106). The packet control unit 231 determines whether the notified CFR request is the update (write) request or the read request (step S107).

When the CFR request is determined to be the update request (YES route in step S107), the own port reading/writing instructing unit 233 and the CFR reading/writing instructing unit 240 write and update the configuration information in the CFR 210 in its own port (step S108). Further, the new request packet (the CFR update request packet) to update the copy CFR 210 is generated by the new request generating unit 232. The generated new request packet is output from the request transmitting unit 270 to the CFR update bus 102, and then transferred to the adjacent port 100 via the CFR update bus 102 (step S109).

Thereafter, the CFR update completion notification generating unit 130 is on standby until all the CFRs 210 are updated (step S110). When the CFR update request packet output from its own port is received by the transmission source check unit 261 and the completion notification is given from the transmission source check unit 261, the CFR update completion notification generating unit 130 determines that all the CFRs 210 have been completely updated. When the completion notification is issued from the transmission source check unit 261 (YES route in step S110), the CFR update completion notification generating unit 130 generates the reply packet to the CPU 10 (step S111). The generated reply packet is output from the CFR update completion notification generating unit 130 to the I/O bus 70 via the transmitting buffer 140, and then transferred to the CPU 10 (step S112).

In step S110, the CFR update completion notification generating unit 130 is on standby until all the CFRs 210 are updated, but since a propagation period of time of the CFR update request is a predictable short period of time, the update may be determined to have been completed when the CFR 210 of its own port is updated. In this case, the CFR update completion notification generating unit 130 determines that the update has been completed when the completion notification is issued from the own port reading/writing instructing unit 233.

Meanwhile, when the CFR request is the read request (NO route in step S107), the own port reading/writing instructing unit 233 and the CFR reading/writing instructing unit 240 read desired configuration information from the CFR 210 in its own port (step S113). A notification of the read data is given to the CFR update completion notification generating unit 130 via the selector 250 (step S114), and the CFR update completion notification generating unit 130 generates a reply packet with the notified read data which is directed to the CPU 10 (step S111). The generated reply packet is output from the CFR update completion notification generating unit 130 to the I/O bus 70 via the transmitting buffer 140, and then transferred to the CPU 10 (step S112).

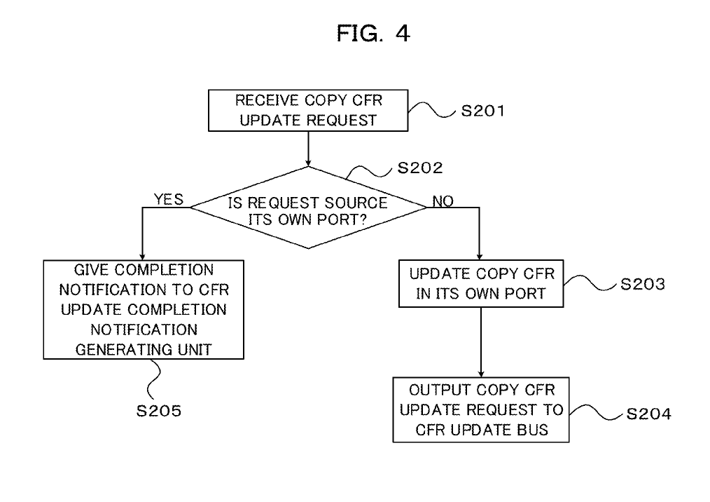

Next, a process (an operation of the copy CFR update request receiving unit 260) when the CFR update request is received in the port 100 having the configuration illustrated in FIG. 2 will be described with reference to a flowchart (steps S201 to S205) illustrated in FIG. 4.

When the copy CFR update request receiving unit 260 receives the CFR update request packet from the adjacent port 100 via the CFR update bus 102 (step S201), first, the transmission source check unit 261 determines whether or not a transmission source of the received packet is its own port (step S202).

When the transmission source of the received packet is determined to be not its own port (NO route in step S202), the reading/writing control unit 262 and the CFR reading/writing instructing unit 240 writes and updates the configuration information in the CFR 210 in its own port based on the received CFR update request (step S203). Further, the received CFR update request packet is output from the request transmitting unit 270 to the CFR update bus 102 as the relay request, and then transferred to the adjacent port 100 via the CFR update bus 102 (step S204).

Meanwhile, when the transmission source of the received packet is determined to be its own port (YES route in step S202), the completion notification is issued from the transmission source check unit 261 to the CFR update completion notification generating unit 130 (step S205). When the completion notification is issued from the transmission source check unit 261 to the CFR update completion notification generating unit 130 (corresponding to YES route in step S110 of FIG. 3), the reply packet to the CPU 10 is generates, and the generated reply packet is transferred to the CPU 10 as described above with reference to FIG. 3.

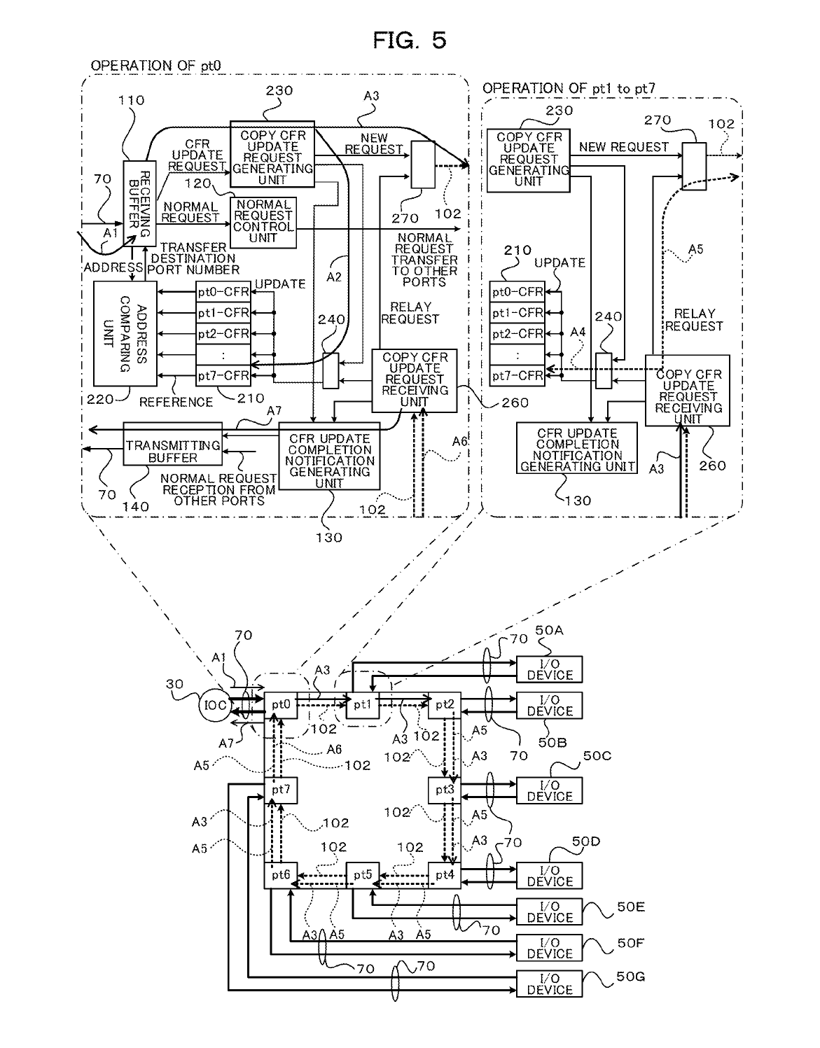

Next, an exemplary CFR update operation in the crossbar switch 40 including the port 100 having the configuration illustrated in FIG. 2 will be described with reference to FIG. 5. In other words, a process of receiving the CFR update request through the upstream port pt0, completing the update process through all the ports pt0 to pt7 using the CFR update bus 102, and transferring the completion notification to the CPU 10 will be described with reference to arrows A1 to A7 of FIG. 5. In FIG. 5, only a configuration related to operations of the ports pt0 to pt7 is illustrated, and a configuration unrelated to operations of the ports pt0 to pt7 is partially not provided.

First, the upstream port pt0 receives the CFR update request packet from the CPU 10 via the I/O bus 70 (see arrow A1). The configuration information is written and updated in the copy CFR 210 in its own port pt0 through the copy CFR update request generating unit 230 in response to the received packet (see arrow A2). Further, the copy CFR update request generating unit 230 generates the new request packet (the CFR update request packet) for updating the copy CFR 210. The generated new request packet is output from the request transmitting unit 270 to the CFR update bus 102, and then transferred to the adjacent port pt1 via the CFR update bus 102 (see arrow A3). Thereafter, the upstream port pt0 is on standby until the configuration information of the copy CFR 210 is updated in the other ports pt1 to pt7, that is, is on standby until the CFR update request packet is returned from the port pt7 via the CFR update bus 102.

In the port pti (i=1 to 7), when the CFR update request packet is received from the port pt (i−1) at the previous stage via the CFR update bus 102, the configuration information is written and updated in the copy CFR 210 in its own port pti via the copy CFR update request receiving unit 260 (see arrow A4). Further, the received packet is output to the CFR update bus 102 as the relay request through the copy CFR update request receiving unit 260 and the request transmitting unit 270, and then transferred to the next adjacent port pt (i+1) via the CFR update bus 102 (see arrow A5).

The transfer destination of the CFR update request packet (the relay request) transferred from the port pt7 is the upstream port pt0, and the CFR update request packet is transferred to the ports pt0, pt1, pt2, pt3, pt4, pt5, pt6, and pt7 in the described order, and finally returns from the port pt7 to the port pt0 (see arrow A6).

When the upstream port pt0 receives the CFR update request packet from the port pt7 via the CFR update bus 102 (see the arrow A6), the transmission source check unit 261 determined whether or not the transmission source of the received packet is its own port. At this time, the transmission source of the received packet is determined to be its own port, the CFR update request received from the port pt7 is discarded, and the completion notification is issued from the transmission source check unit 261 to the CFR update completion notification generating unit 130. Then, the reply packet to the CPU 10 is generated, and the generated reply packet is transferred to the CPU 10 via the transmitting buffer 140 and the I/O bus 70 (see arrow A7).

As described above, in the crossbar switch 40 including the port 100 having the configuration illustrated in FIG. 2, as the CFR update relay port is caused to propagate the CFR update request while updating the copy CFR 210, the update of the copy CFRs 210 of all the ports can be completed. According to this configuration, when the number of ports is N, the N ports are connected in a ring form by the N CFR update buses 102 having a relatively short distance (the largest distance is a distance between adjacent ports), and the update of all the CFRs 210 in the N ports is implemented.

Further, as the CFR update bus 102 is shared, even when there are two or more ports functioning as a port that receives the CFR update, that is, an upstream port, it is possible to cope with it without adding a bus.

Thus, in the crossbar switch 40 including the port 100 having the configuration illustrated in FIG. 2, the similar operation and effect as in the crossbar switch 40 (the information processing apparatus 1) described above with reference to FIG. 1 can be obtained.

[2-2] Port of Second Example

[2-2-1] Configuration of Port of Second Example

FIG. 6 is a block diagram illustrating a configuration of a second example of each port 100 in the crossbar switch 40 of the information processing apparatus 1 illustrated in FIG. 1. The port 100 of the second example illustrated in FIG. 6 has almost the same configuration of the port 100 of the first example illustrated in FIG. 2. Here, the port 100 of the second example illustrated in FIG. 6 differs from the port 100 of the first example illustrated in FIG. 2 in that a port-specific CFR 211 and a read data merging unit 263 are added.

The port-specific CFR (specific register) 211 is added to the copy CFR 210 in the register unit 200 of each port 100, and stores information specific to each port such as various kinds of information related to a state of each port 100 or the like.

In the second example of the port 100, when data is read from or written in the port-specific CFR 211 according to the read/write request given from the CPU 10, the configuration (the CFR update bus 102 or the like) equipped for the CFR update is usable. To this end, in the port 100 of the second example, the read data merging unit 263 is added to the copy CFR update request receiving unit 260. Further, in the second example, a function which will be described later as well the function described in the first example are added to the packet control unit 231, the new request generating unit 232, the own port reading/writing instructing unit 233, the CFR reading/writing instructing unit 240, the selector 250, the transmission source check unit 261, the reading/writing control unit 262, and the CFR update completion notification generating unit 130. Furthermore, in the second example, the CPU 10 issues the read/write request to read or write information from or in the port-specific CFR 211 of each port 100 as well as the update request for the copy CFR 210 and the update information read request for the CFR 210 of the upstream port pt0 as the CFR request.

Next, the function added in the second example and the read data merging unit 263 will be described.

When the CFR request received from the transmission destination determination control unit 112 is the read/write instruction for the port-specific CFR 211 of its own port, the packet control unit 231 outputs the read/write instruction to the own port reading/writing instructing unit 233. When the CFR request received from the transmission destination determination control unit 112 is the read/write instruction for the port-specific CFR 211 of another port, the packet control unit 231 outputs the read/write instruction to the new request generating unit 232.

Upon receiving the read/write instruction for the port-specific CFR 211 of another port from the packet control unit 231, the new request generating unit 232 generates and outputs a new request packet requesting reading/writing according to the read/write instruction.

Upon receiving the read/write instruction for the port-specific CFR 211 of its own port, the own port reading/writing instructing unit 233 gives the read or write instruction for the port-specific CFR 211 of its own port.

The CFR reading/writing instructing unit 240 performs reading or writing on the port-specific CFR 211 according to the read/write instruction given from the copy CFR update request generating unit 230 or the copy CFR update request receiving unit 260.

The selector 250 outputs information read from the port-specific CFR 211 according to the read instruction given from the CFR reading/writing instructing unit 240 as the read data by a selective switching.

The read data merging unit 263 as well as the transmission source check unit 261 and the reading/writing control unit 262 is added to the copy CFR update request receiving unit 260 in the port 100 of the second example.

Upon receiving the read/write request packet for the port-specific CFR 211 from the adjacent port 100 via the CFR update bus 102, the transmission source check unit 261 determines whether or not the packet has been output from its own port with reference to the transmission source information of the packet. When the packet is determined to have been output from its own port, the transmission source check unit 261 determines whether the packet relates to reading or writing. When the packet is determined to relate to writing, the transmission source check unit 261 outputs the completion notification notifying of completion of writing on the port-specific CFR 211 of a certain port to the CFR update completion notification generating unit 130. Further, the packet is determined to relate to reading, the transmission source check unit 261 outputs, along with the read data merged with the packet, the completion notification notifying of completion of reading on the port-specific CFR 211 of a certain port to the CFR update completion notification generating unit 130. Meanwhile, when the packet is determined to have not been output from its own port, the transmission source check unit 261 notifies the reading/writing control unit 262 of the fact that the packet relates to reading/writing on the port-specific CFR 211, and transfers the received packet as the relay packet.

Upon receiving the notification representing that the packet relates to reading/writing on the port-specific CFR 211 from the transmission source check unit 261, the reading/writing control unit 262 determines whether the port-specific CFR 211 of the reading/writing target is the CFR in its own port or the CFR in another port with reference to the register number of the port-specific CFR 211 of the reading/writing target. When the port-specific CFR 211 is determined to be the CFR in another port, the reading/writing control unit 262 transfers the packet to the request transmitting unit 270 as the relay packet. Meanwhile, when the port-specific CFR 211 is determined to be the CFR in its own port, the reading/writing control unit 262 determines whether the packet relates to reading or writing. When the packet is determined to relate to writing, the reading/writing control unit 262 gives the write instruction for the port-specific CFR 211, and transfers the packet to the request transmitting unit 270 as the relay packet through the read data merging unit 263. At this time, the read data merging unit 263 does not function. Further, when the packet is determined to relate to reading, the reading/writing control unit 262 gives the read instruction for the port-specific CFR 211, and transfers the packet to the read data merging unit 263.

The read data merging unit 263 merges read data read from the port-specific CFR 211 according to the read instruction for the port-specific CFR 211 given by the reading/writing control unit 262 with the packet. The read data merging unit 263 transfers the packet merged with the read data to the request transmitting unit 270 as the relay packet.

Upon receiving the completion notification for writing to the port-specific CFR 211 for a certain port from the transmission source check unit 261, the CFR update completion notification generating unit 130 generates the reply packet to the CPU 10, and outputs the reply packet to the transmitting buffer 140. Meanwhile, upon receiving the completion notification for reading from the port-specific CFR 211 for a certain port from the transmission source check unit 261 together with the read data, the CFR update completion notification generating unit 130 generates the reply packet with the read data which is directed to the CPU 10, and outputs the reply packet to the transmitting buffer 140.

[2-2-2] Operation of Port of Second Example

Next, an operation of the port 100 having the configuration illustrated in FIG. 6 and an operation of the crossbar switch 40 including the port 100 having the configuration illustrated in FIG. 6 will be described with reference to FIGS. 7 to 9.

First, a process when a packet is received in the upstream port 100 (pt0) having the configuration illustrated in FIG. 6 will be described with reference to a flowchart (steps S121 to S140) illustrated in FIG. 7.

Upon receiving a packet through the receiving buffer 110 of the upstream port pt0 (step S121), the transmission destination determination control unit 112 determines a type of a packet (step S122). When the transmission destination determination control unit 112 determines that the packet is the memory request packet (“memory request” route in step S122), a notification of a memory request address of the packet is given to the address comparing unit 220. The address comparing unit 220 compares the notified memory request address with the configuration information (address space) stored in the CFR 210 with reference to the CFR 210, and searches for and determines the transfer destination port number identifying the transfer destination port (step S123).

The transfer destination port number is transmitted from the address comparing unit 220 to the transmission destination determination control unit 112, and the transmission destination determination control unit 112 notifies the normal request control unit 120 of the normal request including the transfer destination port number. The normal request control unit 120 transfers the normal request (the memory request) received from the receiving buffer 110 to another port 100 corresponding to the transfer destination port number of the normal request via the packet relay bus 101 (step S124). The memory request packet transferred to the transfer destination port is output from the transfer destination port to the I/O device 50 or the crossbar switch 40 that is under control of the transfer destination port (step S125).

Meanwhile, when the transmission destination determination control unit 112 determines that the packet is the CFR request packet (“CFR request” route in step S122), a notification of the CFR request is given from the receiving buffer 110 to the packet control unit 231 of the copy CFR update request generating unit 230 (step S126). The packet control unit 231 determines whether the notified CFR request is the update request or the read request (step S127).

When the CFR request is determined to be the update request (YES route in step S127), the packet control unit 231 determines whether or not the writing target is the copy CFR 210 with reference to the register number of the writing target (step S128). When the writing target is the copy CFR 210 (YES route in step S128), the own port reading/writing instructing unit 233 and the CFR reading/writing instructing unit 240 write and update the configuration information in the CFR 210 in its own port (step S129). Further, the new request packet (the CFR update request packet) to update the copy CFR 210 is generated by the new request generating unit 232. The generated new request packet is output from the request transmitting unit 270 to the CFR update bus 102, and then transferred to the adjacent port 100 via the CFR update bus 102 (step S130).

Thereafter, the CFR update completion notification generating unit 130 is on standby until all the CFRs 210 are updated (step S131). When the CFR update request packet output from its own port is received by the transmission source check unit 261 and the completion notification is given from the transmission source check unit 261, the CFR update completion notification generating unit 130 determines that all the CFRs 210 have been completely updated. When the completion notification is issued from the transmission source check unit 261 (YES route in step S131), the CFR update completion notification generating unit 130 generates the reply packet to the CPU 10 (step S132). The generated reply packet is output from the CFR update completion notification generating unit 130 to the I/O bus 70 via the transmitting buffer 140, and then transferred to the CPU 10 (step S133).

When the writing target is not the copy CFR 210, that is, when the writing target is the port-specific CFR 211 (NO route in step S128), the packet control unit 231 determined whether the port-specific CFR 211 of the writing target is the CFR in its own port or the CFR in another port (step S134). When the port-specific CFR 211 of the writing target is determined to be the CFR in its own port (a YES route in step S134), the own port reading/writing instructing unit 233 and the CFR reading/writing instructing unit 240 perform writing on the port-specific CFR 211 in its own port (step S135). When the writing on the port-specific CFR 211 in its own port is completed, the completion notification for notifying of the writing completion is given from the own port reading/writing instructing unit 233 to the CFR update completion notification generating unit 130 (step S136). Then, the CFR update completion notification generating unit 130 generates the reply packet for notifying the CPU 10 of the completion of the writing on the port-specific CFR 211 in its own port (step S132). The generated reply packet is output from the CFR update completion notification generating unit 130 to the I/O bus 70 via the transmitting buffer 140, and then transferred to the CPU 10 (step S133).

When the port-specific CFR 211 of the writing target is determined to be the CFR in another port (NO route in step S134), the new request generating unit 232 generates a new request packet (a port-specific CFR write request packet) for performing writing on the port-specific CFR 211 of the writing target in another port. The generated new request packet is outputs from the request transmitting unit 270 to the CFR update bus 102, and then transferred to the adjacent port 100 via the CFR update bus 102 (step S137). Thereafter, the CFR update completion notification generating unit 130 is on standby until the port-specific CFR write request packet output its own port is received by the transmission source check unit 261 and the completion notification is given from the transmission source check unit 261 (step S131). When the completion notification is issued from the transmission source check unit 261 (a YES route in step S131), the CFR update completion notification generating unit 130 generates the reply packet to the CPU 10 (step S132). The generated reply packet is output from the CFR update completion notification generating unit 130 to the I/O bus 70 via the transmitting buffer 140, and then transferred to the CPU 10 (step S133).

Meanwhile, when the CFR request is determined to be the read request (NO route in step S127), the packet control unit 231 determines whether or not the reading target is the copy CFR 210 with reference to the register number of the reading target (step S138). When the reading target is determined to be the copy CFR 210 (YES route in step S138), the own port reading/writing instructing unit 233 and the CFR reading/writing instructing unit 240 reads desired configuration information from the CFR 210 in its own port (step S139). A notification of the read data is given to the CFR update completion notification generating unit 130 via the selector 250 (step S140), and the CFR update completion notification generating unit 130 generates a reply packet with the notified read data which is directed to the CPU 10 (step S132). The generated reply packet is output from the CFR update completion notification generating unit 130 to the I/O bus 70 via the transmitting buffer 140, and then transferred to the CPU 10 (step S133).

When the reading target is determined to be not the copy CFR 210, that is, when the reading target is the port-specific CFR 211 (NO route in step S138), the packet control unit 231 determined whether the port-specific CFR 211 of the reading target is the CFR in its own port or the CFR in another port based on the register number (step S141). When the port-specific CFR 211 of the reading target is determined to be the CFR in its own port (YES route in step S141), the own port reading/writing instructing unit 233 and the CFR reading/writing instructing unit 240 perform reading on the port-specific CFR 211 in its own port (step S139). A notification of the read data is given to the CFR update completion notification generating unit 130 through the selector 250 (step S140), the CFR update completion notification generating unit 130 generates the reply packet with the notified read data which is directed to the CPU 10 (step S132). The generated reply packet is output from the CFR update completion notification generating unit 130 to the I/O bus 70 via the transmitting buffer 140, and transferred to the CPU (step S133).

When the port-specific CFR 211 of the reading target is determined to be the CFR in another port (NO route in step S141), the new request generating unit 232 generates a new request packet (the port-specific CFR read request packet) for performing reading on the port-specific CFR 211 of the reading target in another port. The generated new request packet is output from the request transmitting unit 270 to the CFR update bus 102, and then transferred to the adjacent port 100 via the CFR update bus 102 (step S142). Thereafter, the CFR update completion notification generating unit 130 is on standby until the port-specific CFR read request packet output from its own port is received by the transmission source check unit 261 and the completion notification is given from the transmission source check unit 261 (step S131). The port-specific CFR read request packet returned to its own port includes the read data read from the port-specific CFR 211 for a certain port, and the completion notification given from the transmission source check unit 261 includes the read data. Then, when the transmission source check unit 261 issues the completion notification (YES route in step S131), the CFR update completion notification generating unit 130 generates the reply packet with the read data which is directed to the CPU 10 (step S132). The generated reply packet is output from the CFR update completion notification generating unit 130 to the I/O bus 70 via the transmitting buffer 140, and then transferred to the CPU 10 (step S133).

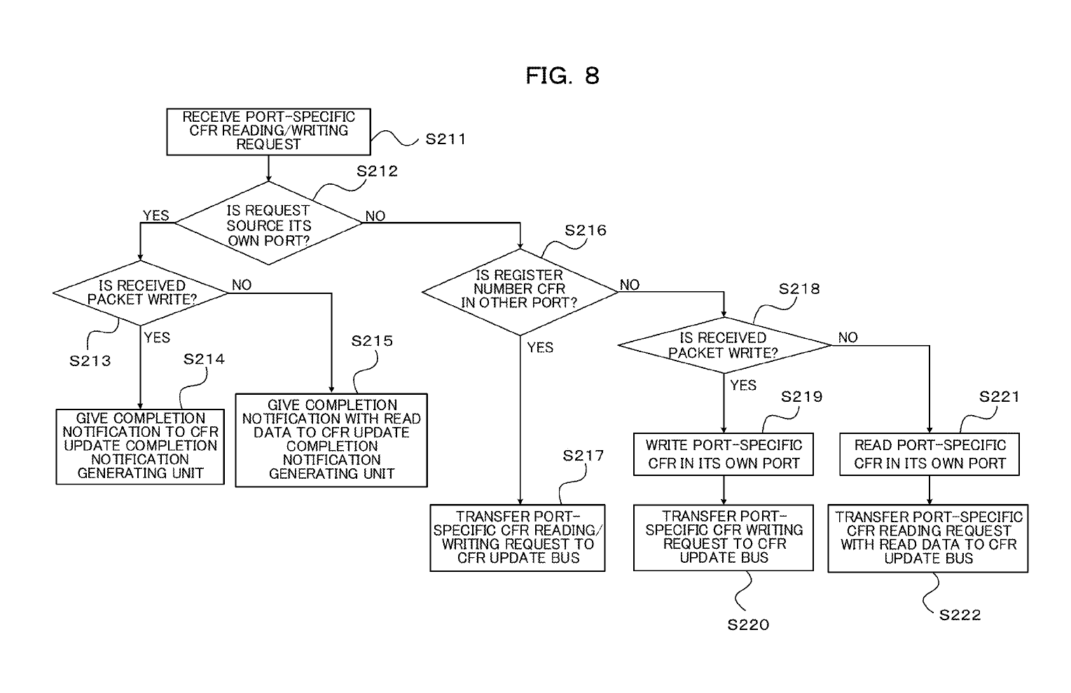

Next, a process (an operation of the copy CFR update request receiving unit 260) when the read/write request for the port-specific CFR 211 is received in the port 100 having the configuration illustrated in FIG. 6 will be described with reference to a flowchart (steps S211 to S222) illustrated in FIG. 8.

When the copy CFR update request receiving unit 260 receives the port-specific CFR read/write request packet from the adjacent port 100 via the CFR update bus 102 (step S211), first, the transmission source check unit 261 determined whether or not the transmission source of the received packet is its own port (step S212).

When the transmission source of the received packet is determined to be its own port (YES route in step S212), the transmission source check unit 261 determined whether the received packet relates to writing or reading (step S213). When the received packet is determined to relate to writing (YES route in step S213), a completion notification for notifying of completion of writing on the port-specific CFR 211 for a certain port is given from the transmission source check unit 261 to the CFR update completion notification generating unit 130 (step S214). Further, when the received packet is determined to relate to reading (NO route in step S213), a completion notification for notifying of completion of reading on the port-specific CFR 211 for a certain port is given from the transmission source check unit 261 to the CFR update completion notification generating unit 130 together with the read data merged with the packet (step S215).

Meanwhile, when the transmission source of the received packet is determined to be not its own port (NO route in step S212), the reading/writing control unit 262 determines whether or not the port-specific CFR 211 of the reading/writing target is the CFR in another port with reference to the register number of the port-specific CFR 211 of the reading/writing target (step S216). When the port-specific CFR 211 is determined to be the CFR in another port (YES route in step S216), the received packet is transferred to the request transmitting unit 270 as the relay packet, and then transferred to the adjacent port 100 via the CFR update bus 102 (step S217).

When the port-specific CFR 211 is determined to be the CFR in its own port (NO route in step S216), the reading/writing control unit 262 determines whether the received packet relate to writing or reading (step S218). When the received packet is determined to relate to writing (YES route in step S218), the reading/writing control unit 262 and the CFR reading/writing instructing unit 240 perform writing on the port-specific CFR 211 (step S219). Further, the received packet is transferred from the reading/writing control unit 262 to the request transmitting unit 270 via the read data merging unit 263 as the relay packet, and then transferred to the adjacent port 100 via the CFR update bus 102 (step S220).

When the received packet is determined to relate to reading (NO route in step S218), the reading/writing control unit 262 and the CFR reading/writing instructing unit 240 read data from the port-specific CFR 211 (step S221). The read data read from the port-specific CFR 211 is merged with the received packet through the read data merging unit 263. The packet merged with the read data is transferred from the read data merging unit 263 to the request transmitting unit 270 as the relay packet, and then transferred to the adjacent port 100 via the CFR update bus 102 (step S222).

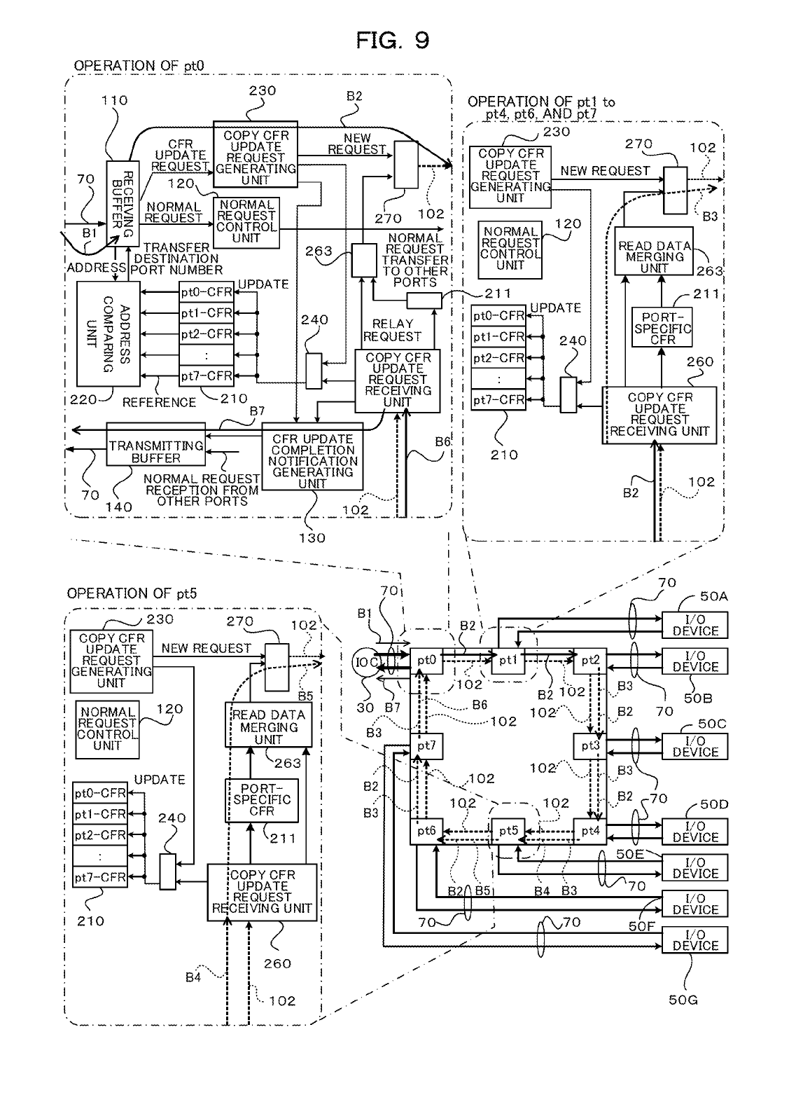

Next, an exemplary port-specific CFR read operation in the crossbar switch 40 including the port 100 having the configuration illustrated in FIG. 6 will be described with reference to FIG. 9. In other words, a process of receiving the port-specific CFR read request for the port pt5 through the upstream port pt0, completing the reading process on the port-specific CFR 211 of the port pt5 using the CFR update bus 102, and transferring the completion notification and the read data to the CPU 10 will be described with reference to allows B1 to B7 of FIG. 9. In FIG. 9, only a configuration related to operations of the ports pt0 to pt7 is illustrated, and a configuration unrelated to operations of the ports pt0 to pt7 is partially not provided.

First, the upstream port pt0 receives the port-specific CFR read request packet for the port pt5 from the CPU 10 via the I/O bus 70 (see arrow B1). The copy CFR update request generating unit 230 generates a new request packet (the port-specific CFR read request packet) for reading data from the port-specific register 211 of the port pt5 in response to the received packet. The generated new request packet is output from the request transmitting unit 270 to the CFR update bus 102, and then transferred to the adjacent port pt1 via the CFR update bus 102 (see arrow B2). Thereafter, the upstream port pt0 is on standby until the port-specific CFR read request packet is returned from the port pt7 via the CFR update bus 102.

The ports pt1 to pt4 receive the port-specific CFR read request packet from the ports pt0 to pt3 at the previous stage via the CFR update bus 102. Since the received packet is unrelated to the ports pt1 to pt4, the received packet is output the CFR update bus 102 as the relay request through the copy CFR update request receiving unit 260 and the request transmitting unit 270 without change, and then transferred the next adjacent ports pt2 to pt5 via the CFR update bus 102 (see arrow B3).

When the port-specific CFR read request packet for the port pt5 is transferred from the port pt4 to the port pt5 (see arrow B4), the copy CFR update request receiving unit 260 reads data from the port-specific CFR 211 in the port pt5. The read data read from the port-specific CFR 211 is merged with the received packet through the read data merging unit 263. The packet merged with the read data is output to the CFR update bus 102 as the relay request through the request transmitting unit 270, and transferred to the next adjacent port pt6 via the CFR update bus 102 (see arrow B5).

In the ports pt6 and pt7, similarly to the ports pt1 to pt4, the port-specific CFR read request packet (the packet with the read data) received from the ports pt5 and pt6 at the previous stage is transferred to the next adjacent ports pt7 and pt0 without change (see arrows B2 and B3).

As a result, the port-specific CFR read request packet is transferred to the ports pt0, pt1, pt2, pt3, pt4, pt5, pt6, and pt7 in the described order, and merged with the read data in the port pt5, and finally returns from the port pt7 to the port pt0 (see arrow B6).

In the upstream port pt0, upon receiving the port-specific CFR read request packet with the read data from the port pt7 via the CFR update bus 102 (see arrow B6), the transmission source check unit 261 determines whether or not the transmission source of the received packet is its own port. At this time, when the transmission source of the received packet is determined to be its own port, the read data merged with the port-specific CFR read request packet is extracted, and the port-specific CFR read request is discarded. Then, the completion notification with the read data is issued from the transmission source check unit 261 to the CFR update completion notification generating unit 130. The CFR update completion notification generating unit 130 generates the reply packet with the read data which is directed to the CPU 10, and transfers the generated reply packet to the CPU 10 through the transmitting buffer 140 and the I/O bus 70 (see arrow B7).

The exemplary operation illustrated in FIG. 9 has been described in connection with the example in which data is read from the port-specific CFR 211 from the port pt5, but reading data from the port-specific CFR 211 of another port can be performed, similarly to the exemplary operation illustrated in FIG. 9. Further, writing data to the port-specific CFR 211 of each port can be also performed, similarly to the exemplary operation illustrated in FIG. 9.

As described above, in the crossbar switch 40 including the port 100 having the configuration illustrated in FIG. 6, the similar operation and effect as the crossbar switch 40 including the port 100 having the configuration illustrated in FIG. 2 are obtained, but reading and writing of data on the port-specific CFR 211 can be performed using the CFR update bus 102 or the like. In other words, as the ports 100 are connected in a ring form through the CFR update bus 102, reading/writing of data on the port-specific CFR 211 distributedly arranged in each port can be implemented.

[2-3] Port of Third Example

[2-3-1] Configuration of Port of Third Example

FIG. 10 is a block diagram illustrating a configuration of a third example of each port 100 in the crossbar switch 40 of the information processing apparatus 1 illustrated in FIG. 1. The port 100 of the third example illustrated in FIG. 10 has almost the same configuration of the port 100 of the second example illustrated in FIG. 6. Here, the port 100 of the third example illustrated in FIG. 10 differs from the port 100 of the second example illustrated in FIG. 6 in that a comparing unit 264 is added to the copy CFR update request receiving unit 260.

The port 100 of the third example has a configuration of transmitting a delivery acknowledgement for a packet that has propagated through the ports pt0 to pt7 that are connected in a ring form through the CFR update bus 102 and returned to the port pt0. To this end, in the port 100 of the third example, the comparing unit 264 is added to the copy CFR update request receiving unit 260, and a function which will be described later as well as the function described in the first and the second example is added to the new request generating unit 232.

Next, the function added in the third example and the comparing unit 264 will be described.

The new request generating unit 232 notifies the comparing unit 264 of all or a part of a new request packet as an expectation value when generating the new request packet to be transmitted to the ports pt0 to pt7 and outputting the new request packet to the CFR update bus 102. As the expectation value, various kinds of information capable of specifying the new request packet may be used instead of all or a part of the new request packet.

When the transmission source check unit 261 determines that the packet received from the adjacent port 100 has been output from its own port, the comparing unit 264 compares the received packet with the expectation value (all or a part of the packet) notified from the new request generating unit 232. In other words, the comparing unit 264 determines whether or not the packet that has propagated through the ports pt0 to pt7 connected in a ring form and returned to the port pt0 is identical to the packet (the request packet received from the CPU 10) generated by the new request generating unit 232.

When the packet received from the adjacent port 100 is identical to the expectation value, the comparing unit 264 gives a completion notification to the CFR update completion notification generating unit 130. Upon receiving the completion notification, the CFR update completion notification generating unit 130 gives the completion notification to the CPU 10 by generating the reply packet corresponding to the completion notification and outputting the generated reply packet to the I/O bus 70 via the transmitting buffer 140.

Meanwhile, when the packet received from the adjacent port 100 is not identical to the expectation value, the comparing unit 264 determines that a certain abnormality occurs when the process of transferring the packet to the ports pt0 to pt7 is performed, and gives a retransmission instruction for the new request packet corresponding to the packet to the new request generating unit 232. Upon receiving the retransmission instruction, the new request generating unit 232 outputs the same new request packet to the CFR update bus 102 again through the request transmitting unit 270, and performs the process of transferring the packet to the ports pt0 to pt7 again. Even when the new request packet re-transfer process is performed, the new request generating unit 232 notifies the comparing unit 264 of the expectation value.

The new request packet re-transfer process is repeatedly performed until the comparing unit 264 determines that the received packet is identical to the expectation value. Further, the CFR update completion notification generating unit 130 may be configured to give an error notification for notifying of that the packet transfer has not been normally completed to the CPU 10 when the comparing unit 264 determines that the received packet is not identical to the expectation value although the new request packet re-transfer process is repeatedly performed a certain number of times.

[2-3-2] Operation of Port of Third Example

Next, a packet delivery acknowledgement process in the upstream port 100 (pt0) having the configuration illustrated in FIG. 10 will be described with reference to a flowchart (S301 to S308) illustrated in FIG. 11.

First, in the new request generating unit 232, a new request packet to be transferred to the ports pt0 to pt7 is generated, and output to the CFR update bus 102 through the request transfer unit 270 (step S301), and the expectation value is generated, a notification of the expectation value is given to the comparing unit 264 (step S302). For example, the expectation value is all or a part of the new request packet as described above, and held in the register of the comparing unit 264 or the like.

Thereafter, when the copy CFR update request receiving unit 260 receives a packet from the adjacent port 100 (YES route in step S303), the transmission source check unit 261 determines whether or not the transmission source of the received packet is its own port (step S304). When the transmission source of the received packet is determined to be not its own port (NO route in step S304), the packet has been neither generated nor transferred by its own port, and thus the copy CFR update request receiving unit 260 returns to the process of step S303 and is on standby for an arrival of another packet.

When the transmission source of the received packet is determined to be its own port (YES route in step S304), the comparing unit 264 compares the received packet with the expectation value (all or a part of the packet) notified from the new request generating unit 232 (step S305).

When the comparing unit 264 determines that the packet that has propagated through the ports pt0 to pt7 and then returned to the port pt0 is identical to the packet generated by the new request generating unit 232 (YES route in step S306), the completion notification is given to the CFR update completion notification generating unit 130 (step S307). The CFR update completion notification generating unit 130 generates the reply packet corresponding to the completion notification, and outputs the generated reply packet to the I/O bus 70 through the transmitting buffer 140, and thus the completion notification is given to the CPU 10.

Meanwhile, when the comparing unit 264 determines that the packet that has propagated through the ports pt0 to pt7 and then returned to the port pt0 is not identical to the packet generated by the new request generating unit 232 (NO route in step S306), the retransmission instruction is given to the new request generating unit 232 (step S308). In other words, when the received packet is not identical to the expectation value, a certain abnormality is determined to have occurred when the process of transferring the packet to the ports pt0 to pt7 is performed, and the retransmission instruction for the new request packet corresponding to the packet is given to the new request generating unit 232. As a result, the process of transferring the packet to the ports pt0 to pt7 is performed again, the copy CFR update request receiving unit 260 proceeds to the process of step S302, and step S302 to step S308 are repeatedly performed until YES is determined in step S306.

As described above, according to the crossbar switch 40 including the port 100 having the configuration illustrated in FIG. 10, the similar operation and effect as in the crossbar switch 40 including the port 100 having the configuration illustrated in FIG. 2 or 6 are obtained, and the packet delivery acknowledgement can be performed. In other words, it is possible to check whether the request packet has properly propagated through the loop configured with the CFR update bus 102 and the ports pt0 to pt7 by comparing the packet (the expectation value) output from the port pt0 with the packet returned to the port pt0.

Further, when the request packet is determined to have not properly propagated, the same request packet is retransmitted, and thus it is possible to transfer various kinds of packets such as the CFR update request packet and the port-specific CFR read/write request packet to each port 100 with a high degree of accuracy.

Further, in the port 100 of the third example, the comparing unit 264 is added to the port 100 of the second example illustrated in FIG. 6 but may be added to the port 100 of the first example illustrated in FIG. 2. In this case, the similar operation and effect as in the port 100 of the third example can be obtained.

[2-4] Port of Fourth Example

[2-4-1] Configuration of Port of Fourth Example

FIG. 12 is a block diagram illustrating a configuration of a fourth example of each port 100 in the crossbar switch 40 of the information processing apparatus 1 illustrated in FIG. 1. The port 100 of the fourth example illustrated in FIG. 12 has almost the same configuration of the port 100 of the second example illustrated in FIG. 6. Here, the port 100 of the fourth example illustrated in FIG. 12 differs from the port 100 of the second example illustrated in FIG. 6 in that a timing adjustment control unit 234 is added to the copy CFR update request generating unit 230.

The port 100 of the fourth example has a configuration of time-dividing a transmission timing of various kinds of packets such as the CFR update request including the configuration information packet or the port-specific CFR read/write request packet by a specific value, and adjusting a request issuable timing. To this end, in the port 100 of the fourth example, the timing adjustment control unit 234 is adjusted to the copy CFR update request generating unit 230, and a function which will be described later as well as the function described above in the first and second examples is added to the packet control unit 231.

The function added in the fourth example and the timing adjustment control unit 234 will be described below.

The packet control unit 231 outputs the request packet to the CFR update bus 102 through the request transmitting unit 270 according to a request issuable timing instruction given from the timing adjustment control unit 234. In other words, the packet control unit 231 controls the new request generating unit 232 such that the request packet is output to the CFR update bus 102, for example, when the request issuable timing instruction given from the timing adjustment control unit 234 is “1” (high). Further, the packet control unit 231 prevents the request packet from being output the CFR update bus 102, thereby prohibiting its own port from issuing a request, for example, when the request issuable timing instruction given from the timing adjustment control unit 234 is “0” (low).

The timing adjustment control unit 234 issues the request issuable timing instruction to the packet control unit 231, and includes a timing adjustment setting register 234a, a selector 234b, and a timing counter 234c as illustrated in FIG. 13. FIG. 13 is a block diagram illustrating a detailed configuration of the timing adjustment control unit 234 in the port 100 of the fourth example illustrated in FIG. 12.

The timing adjustment setting register 234a programs a request issuable timing. In the timing adjustment setting register 234a, “1” is set to a bit corresponding to a timing at which a packet can be issued from its own port, that is, a bit corresponding to the request issuable timing. Further, in the timing adjustment setting register 234a, “0” is set to a bit corresponding to a timing at which its own port is prohibited from issuing a packet.

The selector 234b sequentially selects “1” or “0” set to each bit from a plurality of bits to which “1” or “0” is selected in the timing adjustment setting register 234a according to a count value of the timing counter 234c. The selector 234b issues the selected setting value to the packet control unit 231 as the request issuable timing instruction.

The timing counter 234c counts up the count value at a control period, is reset to zero (0) when the count value reaches a certain value, and periodically outputs the count value from 0 to the certain value as an instruction to be given to the selector 234b.

The selector 234b issues setting values of bits corresponding to the count value of the timing counter 234c from the register 234a to the packet control unit 231.

For example, when 1, 0, 0, 0, 0, 0, 0, 0, 0, and 0 are set to a 0-th bit to a 9-th bit of the register 234a, and the timing counter 234c periodically outputs the count value of 0 to 9 to the selector 234b, the selector 234b operates as follows. In other words, the selector 234b that periodically receives the count value of 0 to 9 from the timing counter 234c outputs the setting values 1, 0, 0, 0, 0, 0, 0, 0, 0, and 0 of the 0-th bit to the 9-th bit of the register 234a to the packet control unit 231 sequentially and periodically. Upon receiving the request issuable timing instruction, the packet control unit 231 repeats a process of allowing request issuance during a control period 0 and then prohibiting request issuance during control periods 1 to 9. Thus, the new request generating unit 232 operates to issue a request once per 10 times.

Further, for example, when 1, 0, 1, and 0 are set to the 0-th bit to the 3-rd bit of the register 234a, and the timing counter 234c periodically outputs the count values of 0 to 3 to the selector 234b, the selector 234b operates as follows. In other words, the selector 234b that periodically receives the count values of 0 to 3 from the timing counter 234c outputs the setting values 1, 0, 1, and 0 of the 0-th bit to the 3-rd bit of the register 234a to the packet control unit 231 sequentially and periodically. Upon receiving the request issuable timing instruction, the packet control unit 231 repeats a process of allowing request issuance during the control periods 0 and 2 and prohibiting request issuance during the control periods 1 and 3. As a result, the new request generating unit 232 operates to repeatedly perform the request generation issuance process and the request generation issuance prohibition process in an alternation manner.

[2-4-2] Operation of Port of Fourth Example

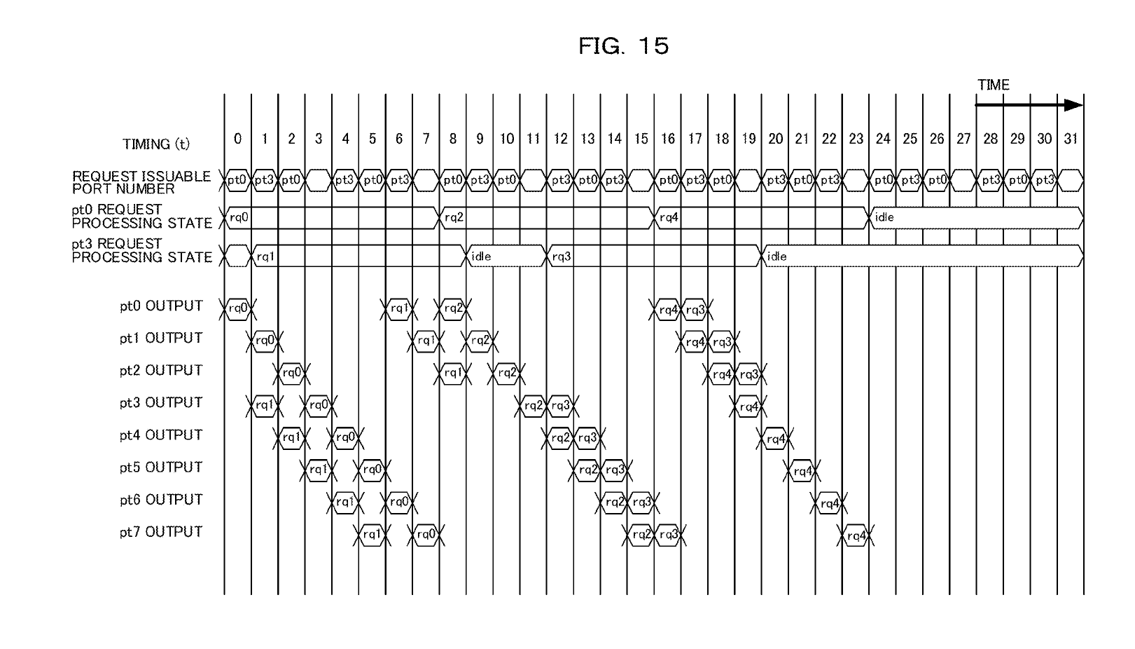

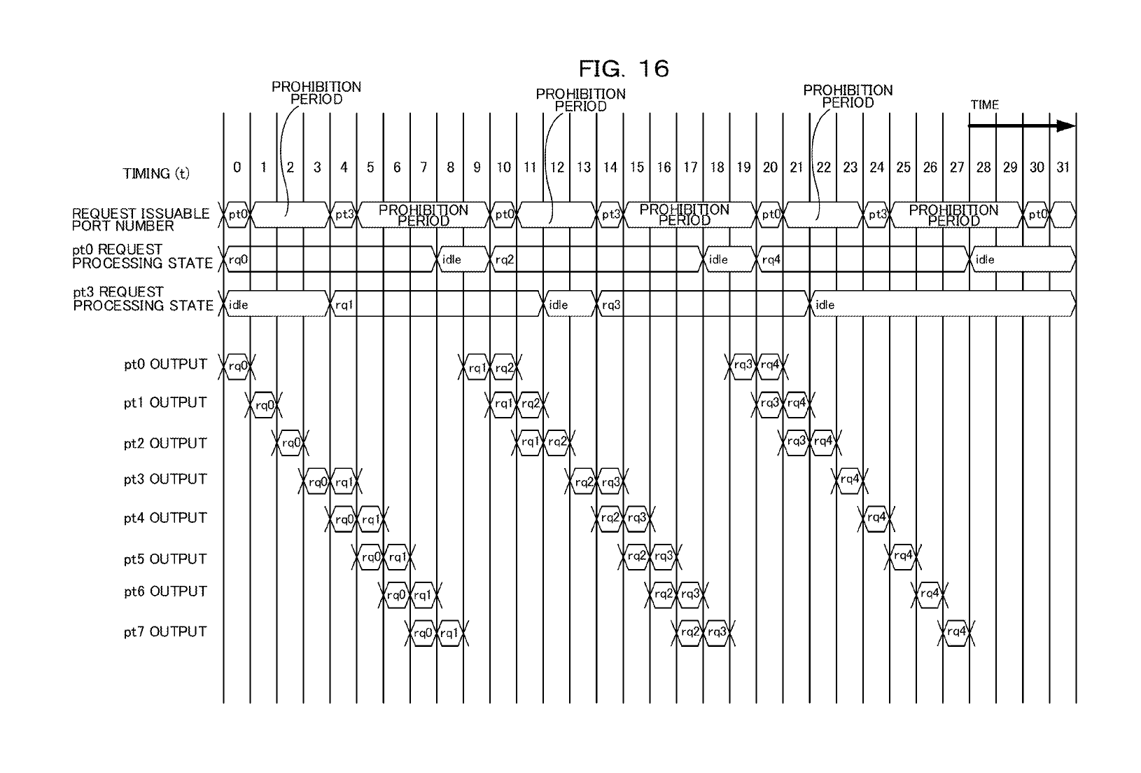

Next, an operation of the crossbar switch 40 including the port 100 having the configuration illustrated in FIGS. 12 and 13 will be concretely described with reference to FIGS. 14 to 16. FIG. 14 is a timing chart for describing exemplary time division (there is no bus output competition) of the CFR update bus 102, and FIG. 15 is a timing chart for describing exemplary time division (there is bus output competition) of the CFR update bus 102. FIG. 16 is a timing chart for describing a request processing order compensation operation performed by the timing adjustment control unit 234 illustrated in FIGS. 12 and 13.

When a single crossbar switch 40 is used in a configuration including two or more upstream ports, that is, when a plurality of I/O trees are mounted on a single crossbar switch 40, the CFR update request packets transferred from the two or more upstream ports are simultaneously processed. In this case, using the port 100 having the configuration illustrated in FIGS. 12 and 13, a timing at which a request is issued to the CFR update bus 102 is time-divided by a specific value, and the request issuable timing by the packet control unit 231 is adjusted. As a result, it is possible to cause request start timings in the two or more upstream ports 100 not to overlap, and thus it is possible to prevent the new request issuance from competing with the reception request relay.

For example, when the two ports pt0 and pt4 among the eight ports 100 in the crossbar switch 40 illustrated in FIG. 1 are the upstream ports, the request issuable timing is alternately switched between the ports pt0 and pt4 through the timing adjustment control units 234 of the ports pt0 and pt4. At this time, values of 1, 0, 1, and 0 are set to the 0-th bit to the 3-bit of the register 234a of the port pt0, the values of 0, 1, 0, and 1 are set to the 0-th bit to the 3-bit of the port pt4, and the timing adjustment control unit 234 of the ports pt0 and pt4 are operated in synchronization with each other. As a result, as illustrated in FIG. 14, the request issuable timing is alternately switched between the ports pt0 and pt4, and when each of the ports pt0 and pt4 transmits a request when its own port is at an issuable timing and a request processing state of its own port is an idle state. Referring FIG. 14, “rq0,” “rq2,” and “rq4” indicate requests issued from the port pt0, and “rq1” and “rq3” indicate requests issued from the port pt4.

In a port combination (pt0 and pt4) illustrated in FIG. 14, a packet relay does not compete with a packet output, and thus the request issuable timing can be alternately set tightly. However, for example, as illustrated in FIG. 15, when the two ports pt0 and pt3 of the eight ports 100 are the upstream ports, it is necessary to insert a spare time at a timing at which bus competition is likely to occur. In the example illustrated in FIG. 15, a spare time is inserted at timings t3, t7, t11, t15, t19, t23, t27, and t31.

When a request issuable timing switching period is short as illustrated in FIG. 15 although bus competition is avoided by insertion of a spare time, an order in which requests are processed by ports is likely to change. For example, at a timing t23 illustrated in FIG. 15, a last processing request in the ports pt0 to pt2 is “rq3,” whereas a last processing request in the ports pt3 to pt7 is “rq4,” and the request processing order is changed.

Typically, when I/O trees are different, target registers to be changed do not overlap, and thus the request processing order is not consequential. However, for example, as illustrated in FIG. 16, the request issuable timing is adjusted by inserting a prohibition period at the request issuable timing so that request overtaking does not occur, and thus the request processing order can be guaranteed.

In the example illustrated in FIG. 16, a prohibition period of a relay time 3τ or more of from the port pt0 to the port pt3 is inserted between an issuable timing of the port pt0 and an issuable timing of the port pt3. Further, a prohibition period of a relay time 5τ or more of from the port pt3 to the port pt0 is inserted between an issuable timing of the port pt3 and an issuable timing of the port pt0. As a result, the request processing order can be guaranteed. At this time, values of 1, 0, 0, 0, 0, 0, 0, 0, 0, and 0 are set to the 0-th bit to the 9-th bit of the register 234a of the port pt0, values of 0, 0, 0, 0, 1, 0, 0, 0, 0, and 0 are set to the 0-th bit to the 9-th bit of the register 234a of the port pt3, and the timing adjustment control units 234 of the ports pt0 and pt3 are operated in synchronization with each other. As a result, as illustrated in FIG. 16, the request issuable timings are alternately switched between the ports pt0 and pt3 while interposing an appropriate prohibition period therebetween, and each of the ports pt0 and pt3 transmits a request when its own port is at an issuable timing, and the request processing state of its own port is an idle state.

As described above, according to the crossbar switch 40 including the port 100 having the configuration illustrated in FIGS. 12 and 13, in addition to the similar operation and effect as in the crossbar switches 40 including the ports 100 having the configuration illustrated in FIGS. 2 and 6, the following operation and effect are obtained. In other words, the request issuable timing by the packet control unit 231 is adjusted by time-dividing a use timing of the CFR update bus 102 connecting the ports 100 connected in a ring form. As a result, even when two or more hierarchical trees are constructed on the crossbar switch 40, that is, even when there are the two or more upstream ports 100, it is possible to prevent requests from a plurality of the CFR update bus 102 from competing with each other.

Further, when the use timing of the CFR update bus 102 is time-divided, the prohibition period appropriate for the request relay time between the two or more upstream ports can be inserted between the request issuable timings of the two or more upstream ports through the timing adjustment control unit 234. As a result, the request issuable timing is adjusted such that the request overtaking does not occur in each port 100, and thus the request processing order can be guaranteed.

Further, in the port 100 of the fourth example, the timing adjustment control unit 234 is added to the port 100 of the second example illustrated in FIG. 6 but may be added to the port 100 of the first example illustrated in FIG. 2 or the port 100 of the third example illustrated in FIG. 10. In this case, the similar operation and effect as in the port 100 of the fourth example can be obtained.

[3] Others

The exemplary embodiments of the present invention have been described above, but the present invention is not limited to a certain relevant embodiment, and various modifications or changes can be made within the scope not departing from the gist of the present invention.

The above embodiments have been described in connection with the example in which the number of ports is 8, but the present invention is not limited to this example.

Further, the above embodiments have been described in connection with the exemplary configuration and the exemplary operations when the port pt0 is the upstream port. However, since the ports pt0 to pt7 are connected in a ring form through the CFR update bus 102, although any port functions as an upstream port, the crossbar switch 40 including the port 100 according to the present embodiment operates through a mechanism similar to that in the above embodiment in a similar manner to the above embodiments.

In addition, all or some of the various functions of the information processing apparatus 1 according to the present embodiment including the transmission destination determination control unit 112, the normal request control unit 120, the CFR update completion notification generating unit 130, the address comparing unit 220, the copy CFR update request generating unit 230 (the packet control unit 231, the new request generating unit 232, the own port reading/writing instructing unit 233, the timing adjustment control unit 234), the CFR reading/writing instructing unit 240, the selector 250, the copy CFR update request receiving unit 260 (the transmission source check unit 261, the reading/writing control unit 262, the read data merging unit 263, and the comparing unit 264), and the request transmitting unit 270 are implemented as a certain program is executed by a computer (including a CPU, an information processing apparatus, and various kinds of terminals).

For example, the program is provided in a form recorded in a computer readable recording medium such as a flexible disk, a CD (a CD-ROM, a CD-R, a CD-RW, or the like), a DVD (a DVD-ROM, a DVD-RAM, a DVD-R, a DVD-RW, a DVD+R, a DVD+RW, or the like), or a Blu-ray disk. In this case, a computer reads the program from the recording medium, transfers the read program to an internal storage device or an external storage device, and then uses the program.

Here, the computer is a concept including hardware and an operating system (OS), and means hardware operating under control of the OS. Further, when an OS is unnecessary and hardware is operated by an application program itself, the hardware corresponds to the computer. The hardware includes at least a microprocessor such as a CPU and a device that reads a computer program recorded in a recording medium. The program includes a program code causing the computer to execute various kinds of functions of the information processing apparatus 1 according to the present embodiment. Further, some of the functions may be implemented by an OS other than an application program.

According to an embodiment, it is possible to reduce a wiring length of a bus connecting a plurality of registers storing configuration information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. A crossbar switch that is installed between a processor and a plurality of I/O devices, the crossbar switch comprising:
a first port that is connected with the processor and stores configuration information of the processor and the plurality of I/O devices;
a second port that is connected to one I/O device among the plurality of I/O devices and stores the configuration information;
a third port that is connected to another I/O device among the plurality of I/O devices and stores the configuration information; and
a bus that connects the first port, the second port, and the third port in a ring form and propagates the configuration information.

2. The crossbar switch according to claim 1,
wherein when the first port receives an update request for the configuration information from the processor, the first port, the second port, and the third port sequentially transfer the update request for the configuration information to adjacent ports via the bus, and
the first port determines whether or not the update request for the configuration information transferred via the bus is identical to the update request for the configuration information received from the processor.

3. The crossbar switch according to claim 2,
wherein when it is determined that the update request for the configuration information transferred via the bus is identical to the update request for the configuration information received from the processor, the first port notifies the processor of completion of the update request for the configuration information.

4. The crossbar switch according to claim 2,
wherein when the first port determines that the update request for the configuration information transferred via the bus is not identical to the update request for the configuration information received from the processor, the first port, the second port, and the third port sequentially transfer the update request for the configuration information to the adjacent ports via the bus again.

5. The crossbar switch according to claim 1,
wherein a request issuable timing is adjusted by time-dividing a transmission timing of the configuration information by a specific value.

6. The crossbar switch according to claim 1,
wherein each of the first port, the second port, and the third port includes a specific register storing port-specific information,
when the first port receives a read request for the specific register from the processor, the first port, the second port, and the third port sequentially transfer the read request for the specific register to adjacent ports via the bus, and sequentially transfer data read from the specific register to the adjacent ports via the bus, and
the first port transmits the data of the specific register transferred via the bus to the processor.

7. The crossbar switch according to claim 1,
wherein each of the first port, the second port, and the third port includes a specific register storing port-specific information, and
when the first port receives a write request for the specific register from the processor, the first port, the second port, and the third port sequentially transfer the write request for the specific register to adjacent ports via the bus.

8. An information processing apparatus comprising:
a processor;
a crossbar switch that is connected to the processor; and
a plurality of I/O devices that are connected to the crossbar switch,
wherein the crossbar switch comprises
a first port that is connected with the processor and stores configuration information of the processor and the plurality of I/O devices,
a second port that is connected to one I/O device among the plurality of I/O devices and stores the configuration information,
a third port that is connected to another I/O device among the plurality of I/O devices and stores the configuration information, and
a bus that connects the first port, the second port, and the third port in a ring form and propagates the configuration information.

9. The information processing apparatus according to claim 8,
wherein when the first port receives an update request for the configuration information from the processor, the first port, the second port, and the third port sequentially transfer the update request for the configuration information to adjacent ports via the bus, and
the first port determines whether or not the update request for the configuration information transferred via the bus is identical to the update request for the configuration information received from the processor.

10. The information processing apparatus according to claim 9,
wherein when it is determined that the update request for the configuration information transferred via the bus is identical to the update request for the configuration information received from the processor, the first port notifies the processor of completion of the update request for the configuration information.

11. The information processing apparatus according to claim 9,
wherein when the first port determines that the update request for the configuration information transferred via the bus is not identical to the update request for the configuration information received from the processor, the first port, the second port, and the third port sequentially transfer the update request for the configuration information to the adjacent ports via the bus again.

12. The information processing apparatus according to claim 8,
wherein a request issuable timing is adjusted by time-dividing a transmission timing of the configuration information by a specific value.

13. The information processing apparatus according to claim 8,
wherein each of the first port, the second port, and the third port includes a specific register storing port-specific information,
when the first port receives a read request for the specific register from the processor, the first port, the second port, and the third port sequentially transfer the read request for the specific register to adjacent ports via the bus, and sequentially transfer data read from the specific register to the adjacent ports via the bus, and
the first port transmits the data of the specific register transferred via the bus to the processor.

14. The information processing apparatus according to claim 8,
wherein each of the first port, the second port, and the third port includes a specific register storing port-specific information, and
when the first port receives a write request for the specific register from the processor, the first port, the second port, and the third port sequentially transfer the write request for the specific register to adjacent ports via the bus.

15. A control method of an information processing apparatus including a processor, a crossbar switch connected to the processor, and a plurality of I/O devices connected to the crossbar switch, the crossbar switch including a first port that is connected with the processor and stores configuration information of the processor and the plurality of I/O devices, a second port that is connected to one I/O device among the plurality of I/O devices and stores the configuration information, and a third port that is connected to another I/O device among the plurality of I/O devices and stores the configuration information, the control method comprising:
connecting the first port, the second port, and the third port in a ring form by a bus propagating the configuration information; and
when the first port receives an update request for the configuration information from the processor, sequentially transferring the update request for the configuration information to adjacent ports via the bus by the first port, the second port, and the third port.

16. The control method of the information processing apparatus according to claim 15,
wherein the first port determines whether or not the update request for the configuration information transferred via the bus is identical to the update request for the configuration information received from the processor.

17. The control method of the information processing apparatus according to claim 16,
wherein when it is determined that the update request for the configuration information transferred via the bus is identical to the update request for the configuration information received from the processor, the first port notifies the processor of completion of the update request for the configuration information.

18. The control method of the information processing apparatus according to claim 16,
wherein when the first port determines that the update request for the configuration information transferred via the bus is not identical to the update request for the configuration information received from the processor, the first port, the second port, and the third port sequentially transfer the update request for the configuration information to the adjacent ports via the bus again.

19. The control method of the information processing apparatus according to claim 15,
wherein a request issuable timing is adjusted by time-dividing a transmission timing of the configuration information by a specific value.

20. The control method of the information processing apparatus according to claim 15,
wherein when the first port receives, from the processor, a read request for a specific register storing port-specific information equipped in each of the first port, the second port, and the third port, the first port, the second port, and the third port sequentially transfer the read request for the specific register to adjacent ports via the bus, and sequentially transfer data read from the specific register to the adjacent ports via the bus, and
the first port transmits the data of the specific register transferred via the bus to the processor.
